(19) United States
(12) Patent Application Publication
(10) Pub. No.: US 2004/0085598 A1
(43) Pub. Date: May 6, 2004

(54) Digital still camera and manufacturing method thereof

(75) Inventors: Noriyuki Kokeguchi, Tokyo (JP); Hirofumi Ohtani, Tokyo (JP)

Correspondence Address: MUSERLIAN AND LUCAS AND MERCANTI, LLP, 475 PARK AVENUE SOUTH, NEW YORK, NY, 10016, US

(73) Assignee: Konica Corporation, Tokyo (JP)

(21) Appl. No.: 10/673,114

(22) Filed: Sep. 26, 2003

(30) Foreign Application Priority Data
Oct. 9, 2002 (JP) JP2002-295946

(51) Int. Cl. H04N 5/225

(52) U.S. Cl. 358/909.1

(57) ABSTRACT

A digital still camera having an organic image sensor for capturing an image; a lens having an aperture value F; and a shutter having a shutter speed T (sec). An exposure value EV of the digital still camera is not less than 6 and not more than 15, where the exposure value EV is represented by the following equation;

EV=3.32 log₁₀ (F²/T).

### BACKGROUND OF THE INVENTION

The present invention relates to a digital still camera provided with an organic image sensor in an image-capturing portion and a manufacturing method thereof.

Prior Art

Generally, a photographing system utilizing a silver halide photographic material has been well known as one of systems with which consumers can easily enjoy photographing images. Silver halide photographic materials can be handled easily and available at a low cost, and have been widely utilized all over the world as an image input means providing high quality images to contributed a great deal to industrial and cultural progress, resulting in being indispensable. Particularly, a silver halide photographic material widely utilized by consumers is a color negative film, however, an image forming process of a color negative film (for example, C-41 standard process by Eastman Kodak Co.) requires processes such as a color development process, a bleaching process, a fixing process and a stabilizing process for color image formation, and has many problems, at present, of such as long processing time, concern on safety handling of processing solutions and influences to environment by processing effluent.

In recent years, a photographic system utilizing a digital still camera has been rapidly prevailing as one of systems to overcome defects of the above-described silver halide light-sensitive material system. The digital still camera equipped with a solid image-capturing device called as a CCD image sensor or a CMOS image sensor which generally includes a photo diode comprised of an inorganic material (for example, a silicon type) in a photoelectric conversion portion. However, even a low-priced digital still camera is by far expensive when compared with such as a lens-attached film unit utilizing a silver halide material system. Further, a digital still camera has exhibited significant progress in an image quality level due to progress of said solid image-capturing device, however, has disadvantages such as of a narrow dynamic range of a light amount at which photographing is possible and of easy generation of blocking of shadows and burning out of highlight. The disadvantages comes from thermal noise of a solid image-capturing device and saturation of charges in a photoelectric conversion portion and are difficult to be overcome, as far as the system aims at a smaller size design, in respect to a manufacturing cost of a solid image-capturing device.

As described above, a photographic system utilizing a silver halide photographic material and a digital still camera system provided with a photo diode comprised of an inorganic material in a photoelectric conversion portion, are coexisting with their advantages and disadvantages, and it is the present state that consumers are making a selection suitably depending on the needs of occasions.

On the other hand, in recent years, researches has been active in the field of an organic electronics utilizing organic materials, such as can be seen in a display material based on organic electroluminescence. Organic materials are expected to produce a new value which cannot be realized by conventional inorganic materials, since they are highly free of shaping to have such as a large area, flatness, a sealed form and flexibility, being capable of realizing multiple functions of, such as input and output, memory and communication by a monolithic structure; being capable of realizing superior device characteristics, environmental adaptability and safety by suitable selection of a material; and applied can be a variety of manufacturing processes such as a low temperature process and a wet process. However, it is a present state that specific techniques for practical application are still on a development stage.

An organic image sensor is characterized by containing an organic material in a photoelectric conversion portion. Examples in which an organic image sensor is utilized for an image input are proposed (for example, refer to patent literatures 1 and 2), however, there is not known an example of a digital still camera application.

Patent Literature 1

JP-A (hereinafter, JP-A refers to Japanese Patent Publication Open to Public Inspection) No. 5-130327 (Scope of claims)

Patent Literature 2

JP-A No. 2000-327815 (Scope of claims)

Problems to be Solved

Therefore, an object of the present invention is to provide a new digital still camera, which overcome each disadvantage of a photographic system utilizing a silver halide photographic material and of a digital still camera system utilizing a solid image-capturing device comprised of an inorganic material, and is provided with a high sensitivity and a wide dynamic range at a low cost, by utilizing an organic image sensor as an image-capturing device; and a manufacturing method thereof.

### SUMMARY OF THE INVENTION

The above object of the invention will be achieved by the following features.

(1) A digital still camera provided with an organic image sensor characterized by having an EV value of not less than 6 and not more than 15.

(2) A digital still camera provided with an organic image sensor characterized by having a system sensitivity index of not less than 0 and not more than 4.5.

(3) A digital still camera provided with an organic image sensor characterized by having a strobe guide number of not more than 10.

(4) A digital still camera provided with an organic image sensor characterized in that an exposure control section applies a fixed-focus and fixed-aperture mode.

(5) A digital still camera provided with an organic image sensor characterized by being reusable through collection after being used.

(6) A digital still camera provided with an organic image sensor characterized in that an aperture area ratio of a photoelectric conversion section of said organic image sensor is not less than 80% and less than 100%.

(7) A digital still camera provided with an organic image sensor characterized in that a size (a side length) of one pixel of said organic image sensor is not less than 2 μn and not more than 200 μm.

(8) A digital still camera provided with an organic image sensor characterized in that a side length of an image-capturing plane of said organic image sensor is not less than 24 mm and not more than 150 mm.

(9) A digital still camera provided with an organic image sensor characterized in that said organic image sensor has at least three maximum spectral sensitivity values and each wavelength, λₘₐₓ₁, λₘₐₓ₂ and λₘₐₓ₃, providing said maximum spectral sensitivity value, satisfies the following formulas (1) to (3).

400 nm<λₘₐₓ₁<500 nm Formula (1)

500 nm<λₘₐₓ₂<600 nm Formula (2)

600 nm<λₘₐₓ₃<700 nm Formula (3)

(10) A digital still camera provided with an organic image sensor characterized in that each wavelength, λ_{max1 (80)},r λ_{max2 (80)} and λ_{max3 (80)}, of said organic image sensor, which provides 80% of the maximum spectral sensitivity value at the longer wave length side of each wavelength, λₘₐₓ₁, λₘₐₓ₂ and λₘₐₓ₃, which provides maximum spectral sensitivity value, satisfies the following formulas (4) to (6).

50 nm≧λ_{max1 (80)}−λₘₐₓ₁≧25 nm Formula (4)

50 nm≧λ_{max2 (80)}−λₘₐₓ₂≧25 nm Formula (5)

50 nM≧λ_{max3 (80)}−λₘₐₓ₂≧25 nm Formula (6)

(11) A digital still camera provided with an organic image sensor characterized in that said organic image sensor comprises multiple lamination layers which are capable of detecting blue-light, green-light and red-light.

(12) A digital still camera provided with an organic image sensor characterized in that a photoelectric conversion portion (section) of said organic image sensor contains titanium oxide, zinc oxide, tin oxide or tungsten oxide.

(13) A digital still camera provided with an organic image sensor characterized in that a photoelectric conversion portion (section) of said organic image sensor contains an organic pigment having a particle diameter of not less than 0.1 nm and not more than 1000 nm.

(14) A digital still camera provided with an organic image sensor characterized in that a photoelectric conversion portion of said organic image sensor contains an electric conductive polymer material.

(15) A digital still camera provided with an organic image sensor characterized in that a photoelectric conversion portion of said organic image sensor contains furalene or a carbon nanotube.

(16) A digital still camera provided with an organic image sensor characterized in that a photoelectric conversion portion of said organic image sensor contains a charge-transporting material.

(17) A digital still camera provided with an organic image sensor characterized in that a photoelectric conversion portion of said organic image sensor contains a hole-transporting material.

(18) A digital still camera provided with an organic image sensor characterized in that an image-capturing plane of said organic image sensor is non-flat.

(19) A digital still camera provided with an organic image sensor characterized in that a generated charge processing portion (section) of said organic image sensor contains an organic semiconductor.

(20) A manufacturing method of a digital still camera provided with an organic image sensor characterized in that said organic image sensor is prepared by an inkjet method in at least one process.

(21) A manufacturing method of a digital still camera provided with an organic image sensor characterized in that said organic image sensor is prepared by a printing method in at least one process of.

### BRIEF DESCRIPTION OF THE DRAWINGS

FIG. 1 is a block diagram showing an example of a digital still camera of the invention.

FIG. 2 is a cross-sectional drawing showing an example of an organic image sensor utilized in the invention.

FIG. 3 is a cross-sectional drawing showing other example of an organic image sensor utilized in the invention.

FIG. 4 is a cross-sectional drawing showing other example of an organic image sensor utilized in the invention.

FIG. 5 is an oblique view drawing showing an example of a digital still camera equipped with a cylindrical sensor (an organic image sensor) of which an image-capturing plane according to the invention is non-flat.

FIG. 6 is a cross-sectional drawing showing an example of a constitution of a cylindrical sensor.

FIG. 7 is a cross-sectional drawing showing an example of an organic image sensor having an organic semiconductor.

FIG. 8 is an oblique view drawing showing an example of an organic TFT constitution.

FIG. 9 is a cross-sectional drawing showing a specific organic TFT constitution and an example of a compound utilized therein.

FIG. 10 is a circuit diagram showing an example of a circuit of an organic image sensor according to the invention.

### DETAILED DESCRIPTION OF THE PREFERRED EMBODIMENT

In what follows, a digital still camera provided with an organic image sensor of the invention will be detailed.

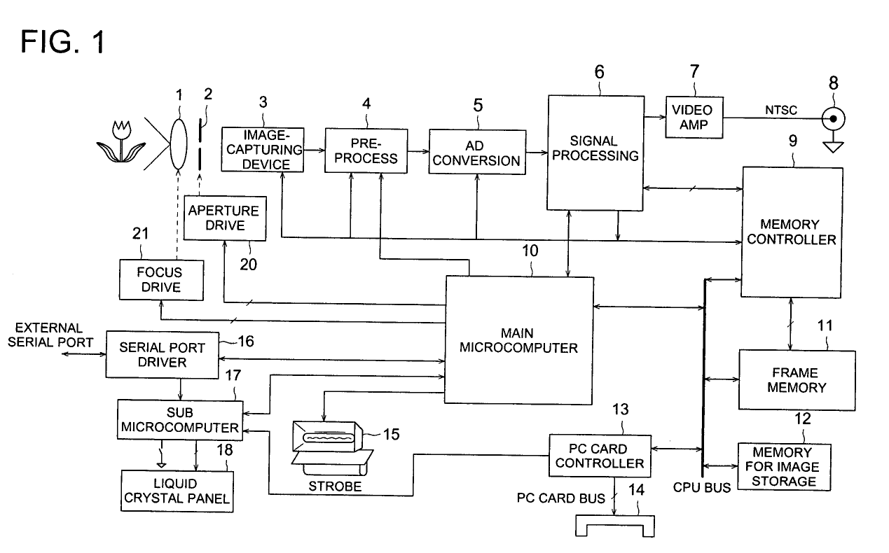

FIG. 1 is a block diagram showing an example of a digital still camera of the invention, and individual movements will be firstly explained.

In FIG. 1, image-capturing device 3 is an organic image sensor characteristic to the invention, and outputs information of an photographic object which has been focused on said image-capturing device 3 through optical camera lens 1, as an electric signal after photoelectric conversion. Pre-process section 4 performs a basic analogue processing before AD conversion such as pre-amplification having a AGC function, clamp and CDS. Further, an AGC standard gain of pre-amplification may also be varied by control of main microcomputer 10.

AD conversion section 5 convert analogue CCD output signals into digital data. Signal processing section 6 provides processes such as filtering process, coloring process and color conversion process to digitized CCD image data and output the data, for example in the form of YCrCb mode, into memory controller 9. On the other hand, signal-processing section 6, which also includes a DA converter, is capable of outputting colored image signals being input from AD converter 5 or image data being input adversely from memory controller 9, as analogue signals. Switching of the functions is performed by data exchange with main microcomputer 10, and exposure information, focus information and white-balance information of CCD signals can be output to main microcomputer 10 appropriately.

In memory controller 9, digital image data are input through signal processing section 6 are stored in frame memory 11, and on the contrary image data in frame memory 11 are output to signal processing section 6. Frame memory 11, which is an image memory capable of storing image data of at least not less than one frame, generally utilizes such as VRAM, SRAM and DRAM and herein utilized is VRAM capable of being driven independently with CPU's bus. Further, this memory may be co-utilized as a system memory. Image storing memory 12 is installed in a main body and images photographed by frame memory 11 are stored after having been treated with such as image compression through main microcomputer 10. As the image storing memory, there can be utilized SRAM, DRAM and EEPROM, however, EEPROM is preferred in consideration of image data storage in the memory.

PC card controller 13 (PCMCIA controller) connects external recording media such as a memory card to main microcomputer 10 and images photographed on a frame memory, after having been subjected to such as image compression, can be recorded on an external recording medium via said PC card controller 13. A PC card can be utilized as an external memory card for storage, which is connected to the system via PC card controller 13. A PC card is a card on which mounted is an electric circuit satisfying physical and electrical specifications defined by guidelines. There are such as a SRAM card, a DRAM card and an EEPROM card as the PC card, and image data can also be transmitted directly to a remote recording medium through a public communication network by use of a modem card or an ISDN card.

Strobe section 15 is a circuit to emit a built-in strobe, and herein the emission timing is obtained from main microcomputer 10 which controls photographing sequence. Serial port driver 16 performs signal conversion for information transmission between a camera main body and external instruments. There are recommended standards known under the names of such as RS-232-C and RS-422-A as a serial transmission means, and herein RS-232-C is applied.

Sub microcomputer 17 controls man-machine interfaces of such as an operation switch of a camera main body and a liquid crystal display, and transmits information to main microcomputer 10 appropriately. Herein, a serial input output terminal is utilized for information transmission with main microcomputer 10. Aperture drive section 20 is, for example, constituted of such as an auto iris and varies optical aperture 2 under control of main microcomputer 10.

Focus drive section 21 is, for example, constituted of a stepping motor, and varies the position of camera lens 1 under control of main computer 10 to adjust an optical focus plane of an photographic object adequate to image-capturing device 3. Main microcomputer 10 mainly controls sequence of photographing, recording and reproducing, and further performs compression and reproduction of photographed images and serial port transmission with external instruments appropriately. Herein, a JPEG method standardized by CCITT and ISO is utilized. Further, herein, the calculation is performed by main microcomputer 10, however it may be also performed by arranging a specified IC for compression and enlargement on a CPU's bus, depending on a capacity of main microcomputer 10.

Next a series of basic movements from photographing to memory recording will be explained. A camera movement mode is set by various switching information connected to sub-microcomputer 17, and information for photographing is output to main microcomputer 10 as serial information. Main microcomputer 10 sets memory controller 9, signal processing section 6 and pre-processing section 4, as well as PC card controller 13 and serial port driver 16 when necessary, according to the information. When a release switch is on, sub microcomputer 17 transmits the information to main microcomputer 10. In main microcomputer image input command is issued to signal processing section 6 at knowing that a release signal is on, and signal processing section 6 drives image-capturing device 3, pre-process section 4 and AD conversion section 5 to receive CCD images. After CCD image data received are subjected to a basic signal processing at signal processing section 5, focus data from high frequency components and exposure data from low frequency components, of brightness data, are prepared. In main microcomputer 10, these data are read from signal processing section 6, and control of aperture driving section 20, focus driving section 21 and further gain of AGC amplifiers in pre-processing section 4 being performed appropriately until obtaining a correct exposure and focus by a converging operation. Further, depending on a movement mode, an analogue image signal is output from signal processing section 6 through connector 8 as an NTSC signal to output to an external monitor. After an exposure value and a focus value are converged to correct values, main microcomputer 10 output a command of reading to memory controller 9 when a signal showing a release switch being pressed is transmitted to main microcomputer 10 from sub microcomputer 17. Further, an emission signal is output to strobe section 15 appropriately at field timing of an image being incorporated. When memory controller 9 receive a command of image incorporation, image data such as of a YCrCb form being output from signal processing section 6 is incorporated into frame memory 11.

When frame memory 11 completes incorporation of an image, memory controller 9 displays a status showing the completion of incorporation, which is read by main microcomputer 10 to confirm completion of photographing in main microcomputer 10. After finishing photographing image compression is performed appropriately in main microcomputer 10, and image data are transmitted to memory for image storage 12, a PC card connected externally or a personal computer connected to an external serial port. At a reproduction and display operation, image data are read by main microcomputer 10 from memory for image storage 12, a PC card externally connected, or a personal computer connected to an external serial port, and are written into frame memory 11 after elongation of image appropriately. Thereafter, when issued is a command for image display to signal processing section 6 and memory controller 9, memory controller 9 read out image data from frame memory 11 to output analogue signals of an image via video amplifier 7 to connector 8, through signal processing section 6 which is an NTSC output terminal. Thus, functions of photographing, recording, regeneration, display and transmission in a camera can be achieved.

In the invention according to feature (1), a digital still camera is characterized by having an EV value of not less than 6 and not more than 15.

An EV value (an Exposure Value) of the invention means the same as in general definition, representing the value which exhibits capability of a camera to pass how much quantity of light depending on a combination of an aperture value F (f-number) and a shutter speed (T second), and is defined by the following formula.

EV=3.32log₁₀ (F²/T)

An EV value according to the invention is preferably not less than 6.5 and less than 11, and more preferably not less than 7.5 and less than 10.

In the above formula, an aperture value F (f-number) represents a quantitative number to define brightness of a lens and is defined as follows.

Aperture value (F)=(Focal distance f)/(Effective aperture of lens D)

The smaller is an aperture value of a lens, the brighter becomes an image focused by the lens. Increasing an effective aperture of a lens is considered to make an aperture value of a lens small, however, a focal depth becomes shallow and an image is liable to blur when an aperture of a lens is increased, resulting in requiring a focus control device. Therefore, to decrease an aperture value of a lens, exposure light quantity per unit area of an image-capturing plane can be increased by making an image-capturing plane size small in accordance to a short focal distance. An aperture value to obtain the above EV value is preferably not less than 2 and less than 8.5, more preferably not less than 2.5 and less than 6.5 and specifically preferably not less than 2.8 and less than 5.6. A shutter speed is preferably not less than 1/150 second and not more than 1/25 second and specifically preferably not less than 1/100 second and not more than 1/50 second.

A lens utilized in the invention has preferably a focal distance of approximately 5-20 mm. A lens constitution may be of single, however, a two-lens by two-group constitution is preferable; it is preferred that a constitution of the first lens with a minus refraction and the second lens with a plus refraction in case of a two-lens by two-group constitution.

In the invention according to feature (2), a digital still camera is characterized by the system sensitivity index being not less than 0 and not more than 4.5.

In the invention, a system sensitivity index is defined by the following formula.

System sensitivity index S=EV value−Image-capturing device sensitivity index SV In case of a silver halide photographic material system, a sensitivity index of an image-capturing device SV can be replaced by a film sensitivity index SV (=3.32 log₁₀(0.3× film ISO sensitivity)). An image-capturing device sensitivity index SV can be calculated by the following formula after obtaining an ISO sensitivity of an image-capturing device in contrast to a film according to a method, for example, described in Pre-print Publication of International Congress of Imaging Science 2002, p.120.

Image-capturing device sensitivity index SV=3.32 log₁₀(0.3× Image-capturing device ISO sensitivity)

As is defined in the invention, defining a system sensitivity index not less than 0 and not more than 4.5 enables photographing without use of a strobe even under cloudy or rainy climate or at indoor photographing, where photographing by use of a strobe is conventionally required.

In the invention, an image-capturing device sensitivity index SV is not less than 0 and not more than 4.0 and preferably not less than 0 and not more than 3.5. Further, an image-capturing device ISO sensitivity is preferably not less than 800 and more preferably not less than 1600.

In the invention according to feature (3), a digital still camera is characterized by the strobe guide number being not more than 10.

In case of utilizing an organic image sensor according to the invention, a strobe having a depressed quantity of strobe light is preferably mounted because a photographing system with a sensitivity higher than conventional ones can be designed. A strobe guide number is specifically preferably not more than 8.

In the invention according to feature (4), a digital still camera provided with an organic image sensor is characterized by being a fixed-focus and fixed-aperture type.

By adopting fixed-focus and fixed-aperture mode, control of aperture drive 20 and focus drive 21 by main microcomputer 10 becomes unnecessary and an equipment size is possible to be minimized.

By combining the inventions according to features (1) to (4), it is possible to provide a low cost digital still camera system.

In order to achieve a digital still camera described in the above features (1) to (4), the organic image sensor to be utilized in the present invention is preferably having characteristics of high sensitivity and wide dynamic range. By the organic image sensors described in features (6) to (10), the characteristics of high sensitivity and wide dynamic range can be attained. Therefore, by utilizing the organic image sensors described in features (6) to (10) for the digital still camera of features (1) to (4), a digital still camera with preferable characteristics can be attained. Namely, a low cost digital still camera, which ensures a high image quality photograph can be attained.

In the invention according to feature (5), a digital still camera provided with an organic image sensor is characterized by capability of reuse by recycle. A method to reuse a digital still camera in a similar manner to a lens-attached film unit is briefly shown in the following process flow.

That is to say, images photographed by consumers by use of the digital still camera are recorded as image signals on a memory as an internal recording medium, however, the constitution does not allow consumers to read out image signals from the memory nor to write them on a removable memory card. Therefore, consumers bring a digital still camera, of which memory image signals are recorded on, to a stores corresponding to camera stores or DPE stores. Then, in stores or places like photofinishers in business-relation therewith, image signals are read out to be printed out or to be written on an external recording medium such as a magnetic disk or a memory card to be delivered to consumers. Thereby, consumers can obtain prints or retrieve images into a personal computer. The external recording medium may be either one prepared by such as stores or one brought in by consumers. While, image signals are erased from a memory in such as stores and the digital still camera is recovered in such as manufacturers. Image signal erasing may be performed also by a manufacturer. In a manufacturer, all the parts are inspected to reuse usable parts for digital still cameras to be newly produced. A digital still camera constituted of fewer structural parts compared to a lens-attached film unit and generally there causes fewer defective parts. However, many of outer package parts cannot be reused due to flaws or dirt. Herein, to establish such a recycle system of a digital still camera, it is desirable that image signals memorized in a digital still camera are coded, being made impossible to be decoded by consumers, and, further, that a specific pass word is required for reading out of image signals.

In the invention according to feature (6), a digital still camera is characterized in that an aperture area ratio of a photoelectric conversion portion of an organic image sensor is not less than 80% and less than 100%.

An aperture area ratio of a photoelectric conversion portion of an organic image sensor referred to in the invention is defined as a ratio of an area of a photo receptor portion, having a light transmittance of not less than 10% at each wavelength between 400 nm and 700 nm, to the total area of a photoelectric conversion portion. The large aperture area ratio defined by the invention enables advantageous device design with respect to sensitivity and a dynamic range which are necessary functions for a digital still camera. In the invention, constitutions requiring no color filters and micro-lens allays are desirable.

In the invention according to feature (7), a digital still camera provided with an organic image sensor is characterized in that a size of one pixel of an organic image sensor is not less than 2 μm and not more than 200 μm.

A size of one pixel referred to in the invention is defined by a length of a maximum long axis that crosses the weight center of an pixel, irrespective whether the shape of an pixel is any of square, rectangular, octahedral, etc. In case of a size of an pixel is less than 2 μm, increasing a number of an pixel in a certain image-capturing plane area is possible, however, an electric charge capacity per one pixel is decreased to make a dynamic range against a possible light quantity of photographing narrow; while in case of the size is over 200 μm, inconvenience occurs in that size compression of a image-capturing portion becomes difficult in respect to a required resolution. A preferable size of one pixel is not less than 2.5 μm and not more than 200 μm, and more preferably not less than 5 μm and not more than 200 μm, and further, most preferably not less than 20 μm and not more than 200 μm.

In the invention according to feature (8), a digital still camera provided with an organic image sensor is characterized in that one edge of a image-capturing plane size of said organic image sensor is not less than 24 mm and not more than 150 mm. And more preferably the size is not less than 35 mm and not more than 150 mm. In case of an image-capturing plane size is not more than 24 mm, it is advantageous in making a camera size small and increasing a F value at the time of photographing, however, a size of one pixel must be made small with respect to a required resolution which decreases a dynamic range against a possible light quantity of photographing; while in case of not less than 150 mm, there are inconveniences of increasing a camera size, decreasing an operation speed and increasing electric power consumption.

In the invention according to feature (9), a digital still camera provided with an organic image sensor is characterized in that an organic image sensor has at least three maximum spectral sensitivity values and each of wavelengths giving said maximum spectral sensitivity values, λₘₐₓ₁, λₘₐₓ₂ and λₘₐₓ₃, satisfies the following formulas (1) to (3).

400 nm<λₘₐₓ₁<500 nm Formula (1)

500 nm<λₘₐₓ₂<600 nm Formula (2)

600 nm<λₘₐₓ₃<700 nm Formula (3)

Photographing of color images having excellent color reproduction is possible by satisfying formulas (1) to (3) by the above-described λₘₐₓ₁, λₘₐₓ₂ and λₘₐₓ₃. Preferable ranges of λₘₐₓ₁ to λₘₐₓ₃ are as follows:

420 nm<ₘₐₓ₁<480 nm, 520 nm<λₘₐₓ₂<580 nm, 620 nm<λₘₐₓ₃<680 nm,

and more preferably:

430 nm<λₘₐₓ₁<470 nm, 530 nm<λₘₐₓ₂<570 nm, 630 nm<λₘₐₓ₃<670 nm.

A method to provide maximum values of spectral Sensitivity defined by the invention may be a constitution utilizing a color filter at an incident light side of a photoelectric conversion portion or a constitution utilizing materials of which a photoelectric conversion portion having spectral sensitivities themselves without using a color filter, and the later without utilizing a color filter is preferred. Wavelengths providing maximum values of spectral sensitivity may exist not less than three, however, at least three of them are required to satisfy the above formulas (1) to (3).

The invention according to feature (10) is characterized in that each wavelength, λ_{max1 (80)}, λ_{max2 (80)} and λ_{max3 (80)}, of said organic image sensor, which provides 80% of the maximum spectral sensitivity value at the longer wave length side of each wavelength, λₘₐₓ₁, λₘₐₓ₂ and λₘₐₓ₃, which provides a maximum spectral sensitivity value, satisfies the following formulas (4) to (6).

50 nm≧λₘₐₓ₁₍₈₀₎−λₘₐₓ₁≧25 nm Formula (4)

50 nm≧λₘₐₓ₂₍₈₀₎−λₘₐₓ₂≧25 nm Formula (5)

50 nm≧λₘₐₓ₃₍₈₀₎−λₘₐₓ₃≧25 nm Formula (6)

In the invention, a constitution in which a difference between a wavelength providing a maximum spectral sensitivity value and a wavelength providing 80% of a maximum spectral sensitivity value is not less than 25 nm in each spectral sensitivity region, enables detection with high sensitivity. However, it is not preferred that a cross talk occurs to deteriorate color reproduction in case of the difference exceeds 50 nm.

What is described above is a definition with respect to the longer wavelength side of a wavelength providing a maximum spectral sensitivity, and it is also preferable with respect to the shorter wavelength side that the difference is not less than 25 nm and not more than 50 nm.

In the invention according to feature (11), a digital still camera is characterized by including an organic image sensor capable of detecting blue-light, green-light and red-light accumulatively.

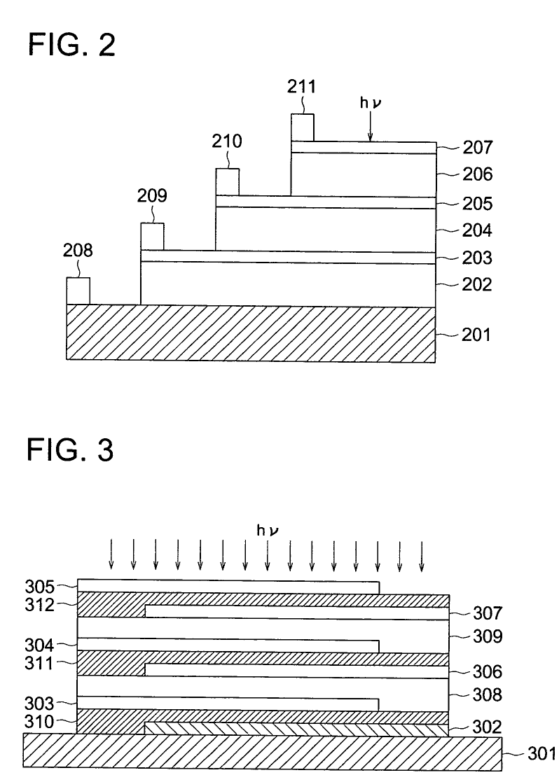

FIGS. 2 to 4 are cross-sectional drawings to show an example of an organic image sensor utilizable in the invention.

FIG. 2 shows an example of an organic image sensor in which metal electrodes 208 to 211, transparent electrodes 203, 205 and 207, red-light detecting layer 202, green-light detecting layer 204 and blue-light detecting layer 206 are accumulated on electric conductive substrate 201. The details of an organic image sensor according to the above constitution can be referred to the description of such as JP-A No. 5-343661.

FIG. 3 shows an example of an organic image sensor in which metal electrode 302, transparent electrodes 303 to 305, dielectric layers 308 and 309, blue-light detecting layer 312, green-light detecting layer 311 and red-light detecting layer 310 are accumulated on transparent support 301. The details of an organic image sensor according to the above constitution can be referred to the description of such as WO No. 2002-502120.

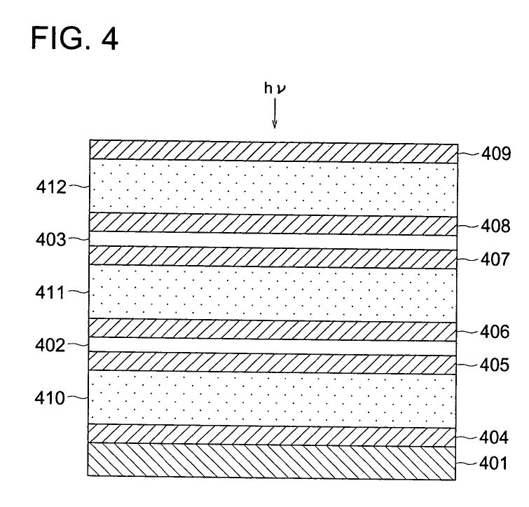

FIG. 4 shows an example of an organic image sensor in which insulating layers 402 and 403, electrodes 404 to 409, blue-light detecting layer 410, green-light detecting layer 411 and red-light detecting layer 412 are accumulated on transparent support 401. The details of an organic image sensor according to the above constitution can be referred to the description of such as JP-A No. 2002-217474.

By utilizing an organic image sensor in which blue-light, green-light and red-light detecting layers are accumulated as shown in FIGS. 2 to 4, for example, as image-capturing device 3 described in FIG. 1, color filters in an image-capturing system of a digital still camera is eliminated to enable detection of visible light most efficiently with the same area of an image-capturing plane.

In an organic image sensor according to the invention, a transparent support includes, for example, polyolefin film such as polyethylene, polystyrene film, polycarbonate film, cellulose derivative film such as cellulose acetate, polyester film such as polyethylene terephthalate and polyethylene naphthalate, polyester film in which a substituent such as a polar group is introduced, film such as polyimide which is prepared by a reaction of pyromelitic acid or anhydide thereof and diamine, and soda-lime float glass. Further, as a transparent electrode, can be utilized a thin film or fine particle dispersion of, for example, electric conductive metals such as gold, silver, copper, platinum, aluminum and nickel; and electric conductive metal oxides such as an indium-tin oxide compound, a fluorine-tin oxide compound and an aluminum doped zinc oxide compound. Further, as a metal electrode can be made of such as Cs, Sm, Y, Mg, Al, In, Cu, Ag and Au, and metals which provide a work function larger than that of a transparent electrode are preferably utilized.

In the invention according to feature (12), a digital still camera is characterized in that a photoelectric conversion portion of an organic image sensor includes titanium oxide, zinc oxide, tin oxide or tungsten oxide.

A photoelectric conversion portion of the invention refers to a portion where electric conductivity is generated corresponding to an excitation wavelength when being photo-exited by light in a specific intrinsic wavelength region. Generally utilized are photoconductors for photoelectric conversion, and titanium oxide, zinc oxide, tin oxide or tungsten oxide according to the invention are most preferably utilized as an n-type inorganic photoconductor material also in respect to durability.

In the invention, can be also utilized for a photoelectric conversion portion, n-type photoconductors comprised of Si, CdS, CdSe, ZnS, ZnSe, FeS₂, PbS, InP, GaAs, TiSrO₃, CuInS₂ and CuInSe₂ as a main component, and p-type phorto-conductors comprised of Cu₂O, GaP, NiO, CoO, FeO, Cr₂O₃, SnS, Bi₂O₃, Si and Ge as a main component. These photoconductors may be also utilized by being doped with impurities, and can be utilized as fine particles having a mean particle diameter of 0.1-100 nm or in a porous state of aggregated fine particles.

In a photoelectric conversion portion containing the above-described inorganic semiconductor material, preferably utilized are dyes represented by general formula (I) to (V) described in JP-A No. 2001-217451. Further, utilized as an electrolyte can be compounds described in column Nos. 0106 to 0131 of JP-A No. 2001-217451.

In the invention according to feature (13), a digital still camera is characterized in that a photoelectric conversion portion of an organic image sensor includes an organic pigment having a particle diameter of not less then 0.1 nm and not more than 1000 nm.

Organic pigments can be utilized in the invention include, for example, anthraquinone series such as amino anthraquinone series, anthrapyrimidine series, furapathorone series, anthoanthorone series, indathrone series, pyranthrone series and pyoranthrone series; condensced ring pigments such as perylene series, perynone series, quinacridone series, thoindigo series, dioxadine siries, isoindolinone series and quinophtharone series; copper phtharocyanine, copper phthalosyanine halogenide and copper phthalocyanine sulfonate lake series, metal free phthalocyanine series pigment, azo lake pigments insoluble azo pigments or condensed azo pigments such as acetoacetate anilide series, pyrazolone series, β-napthol series, β-oxynaphthoate series and β-oxynaphthoate anilide series; nitroso pigments; nitro pigments; threne pigments; diketopyrrolole pigments and metal complex pigments. A particle diameter of organic pigments is required to be not less than 1 nm and not more than 1000 nm in respect to increasing an efficiency of electron or hole transmission and more preferably not less than 1 nm and not more than 800 nm. As a method to obtain an organic pigment having a particle diameter defined by the invention, can be utilized are such as a liquid phase method, a gas phase method and a crushing method.

In what follows, specific examples preferably utilized in the invention will be shown, however, the invention is not limited thereto.

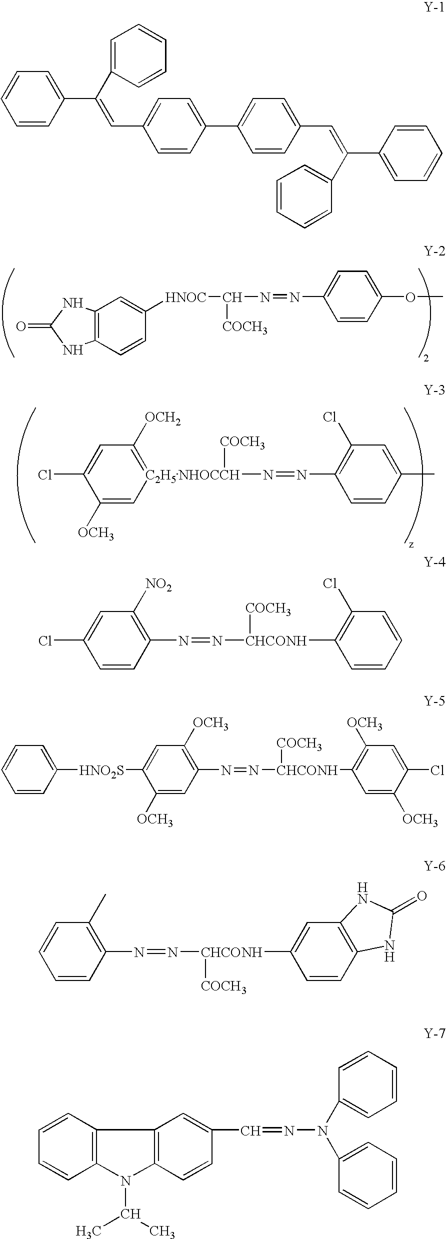

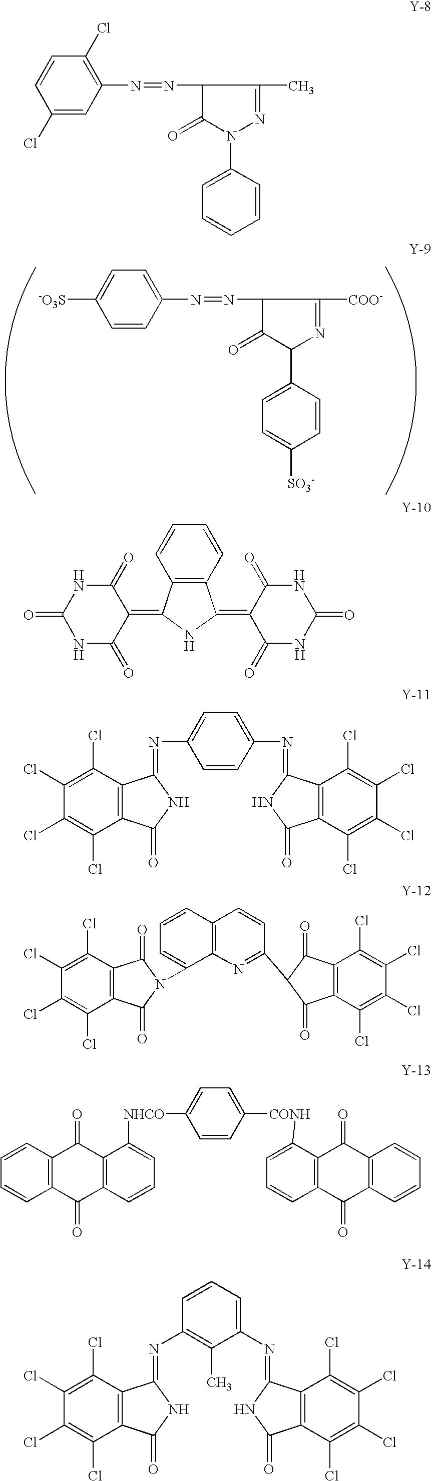

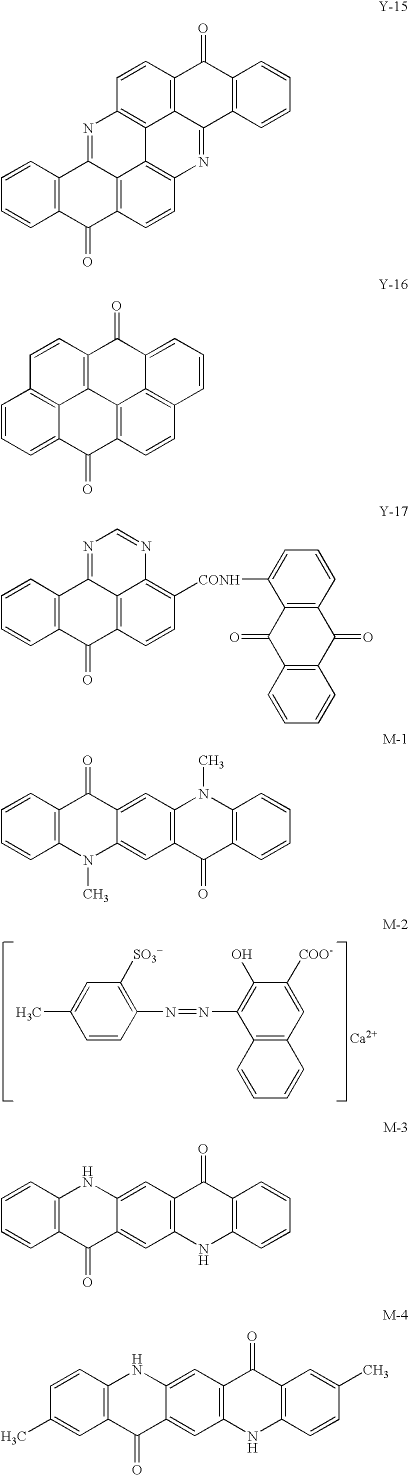

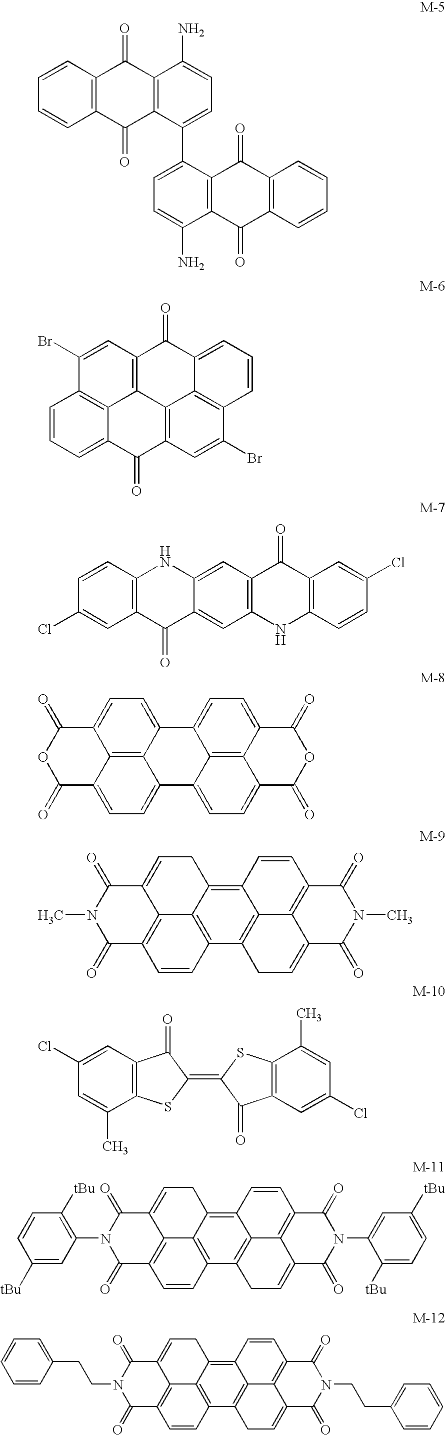

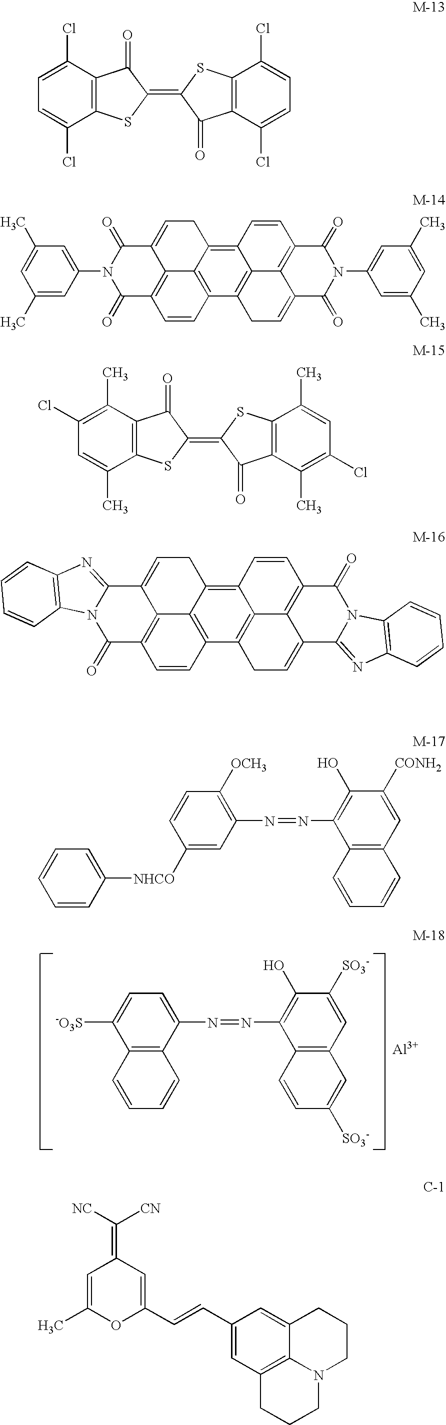

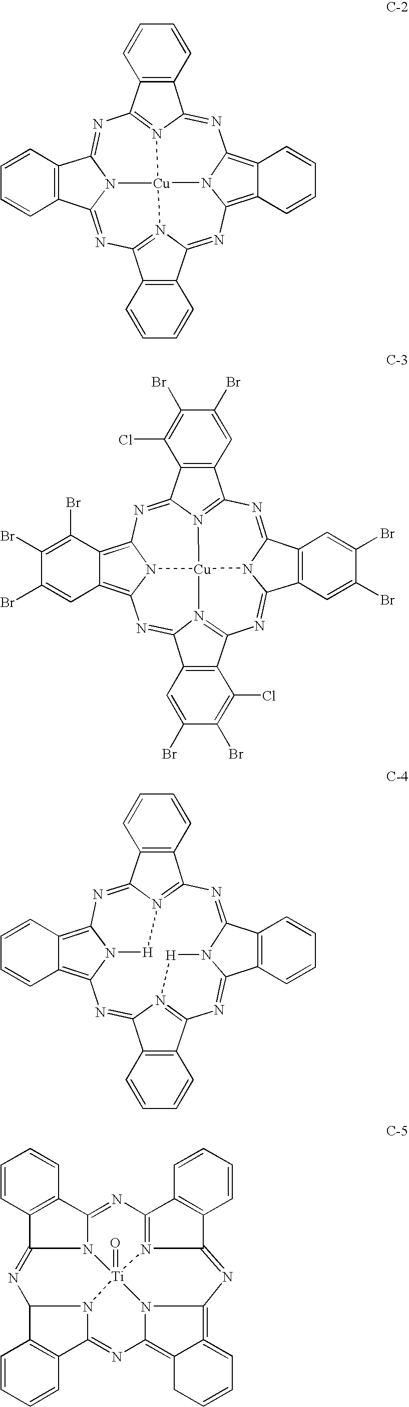

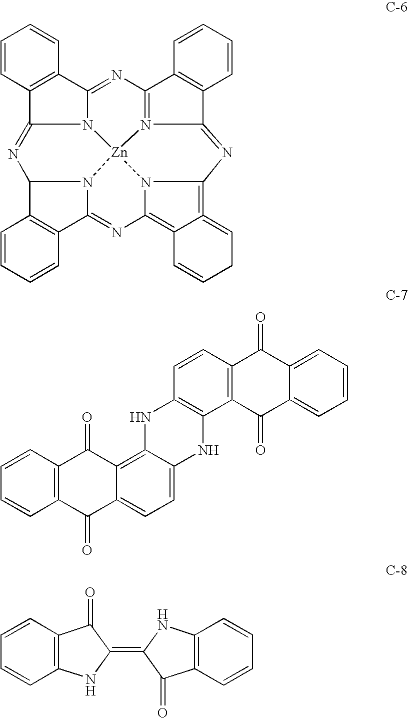

In the invention according to feature (14), a digital still camera is characterized in that a photoelectric conversion portion of an organic image sensor contains an electric conductive polymer material.

An electric conductive polymer of the invention refers to a polymer compound having an electric conductivity of not less than 0.1 S/cm. Preferable specific examples of electric conductive polymer materials utilized in the invention are listed below, however, the invention is not limited thereto.

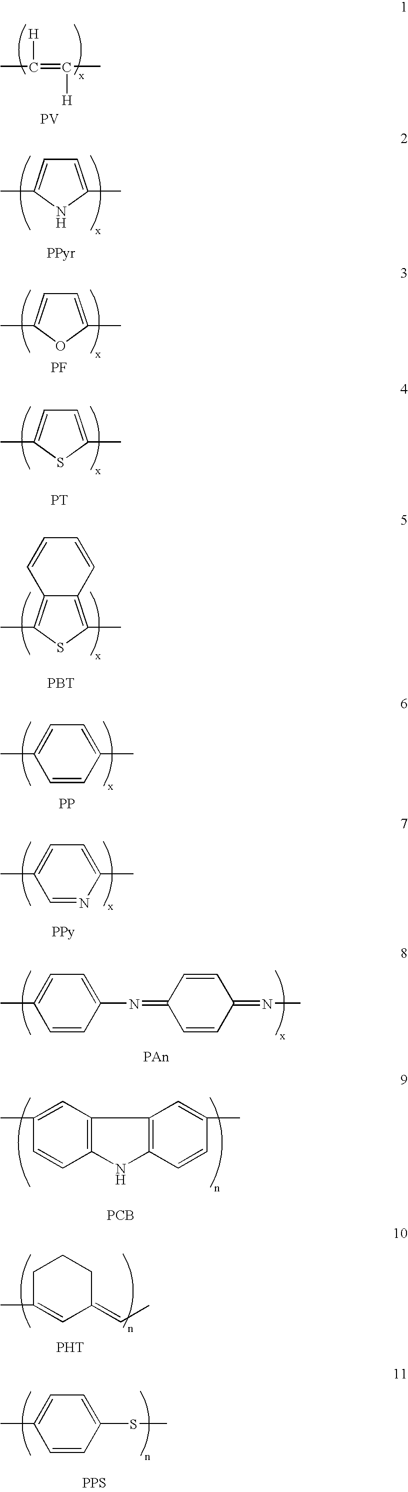

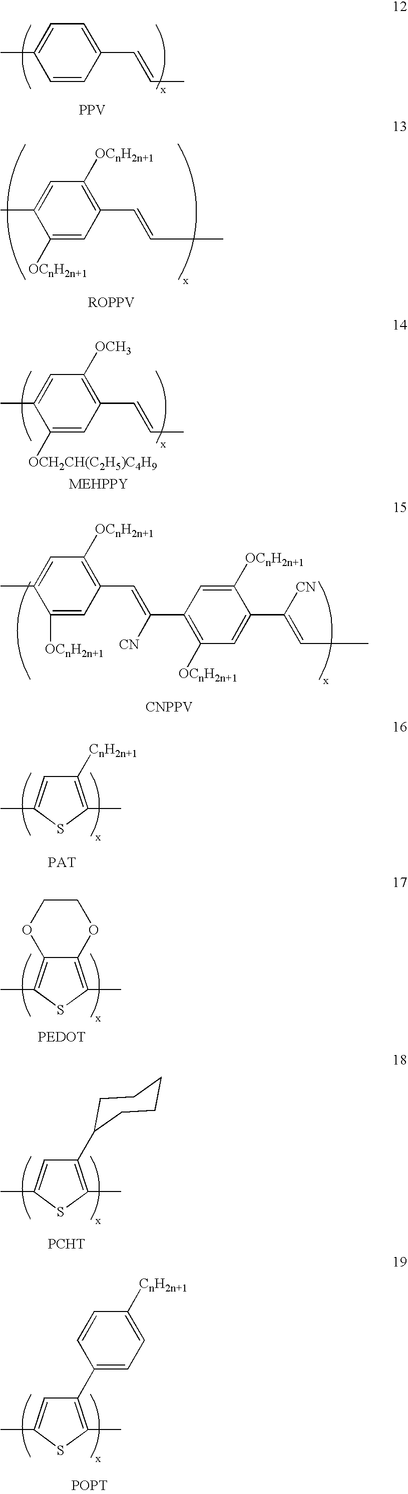

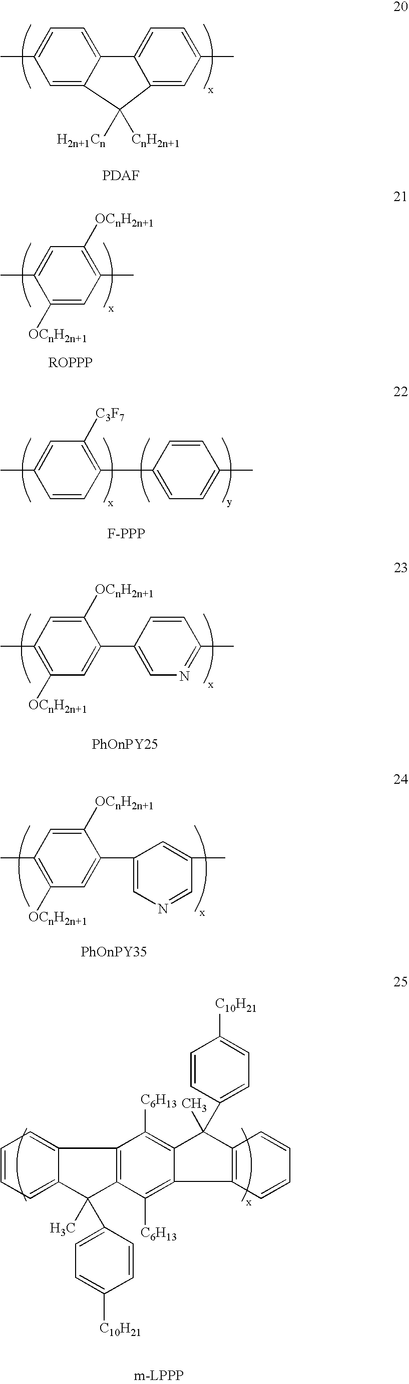

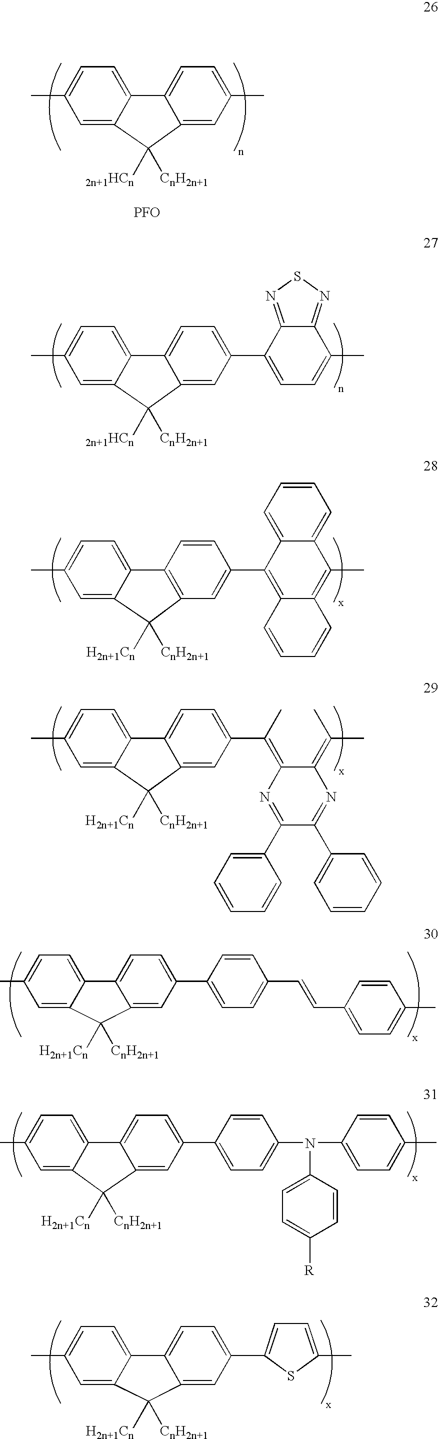

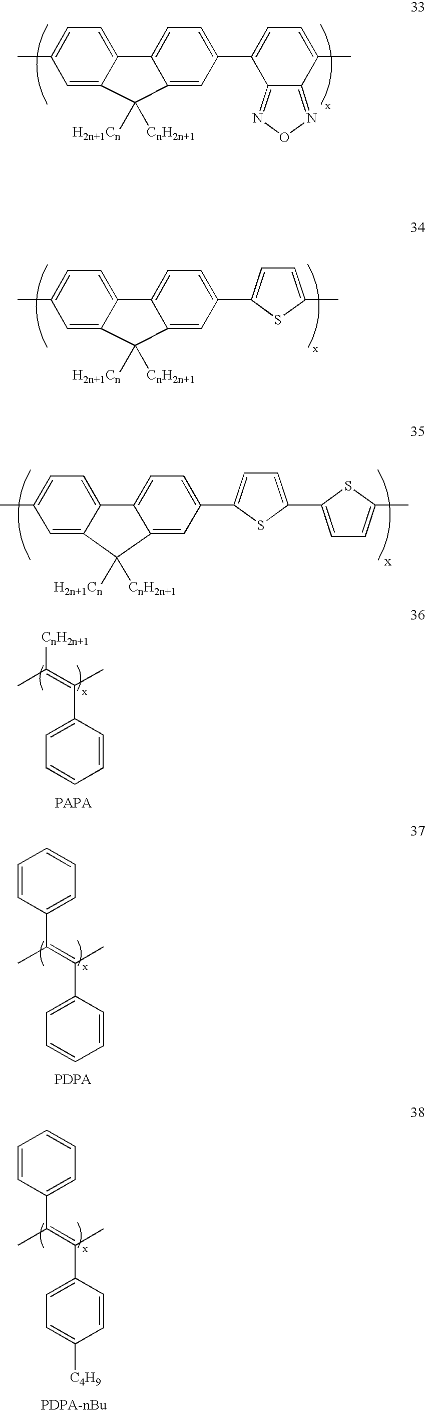

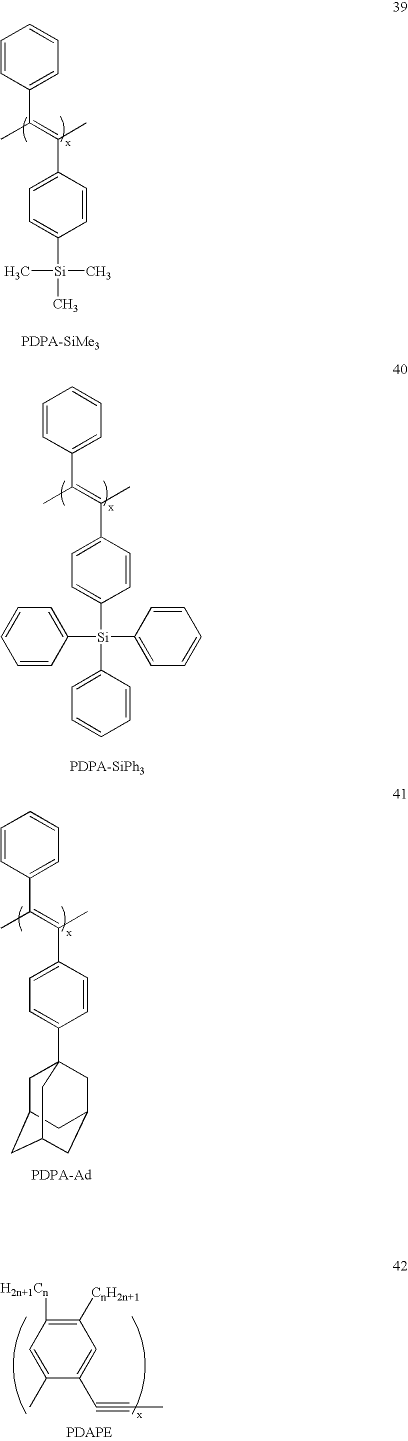

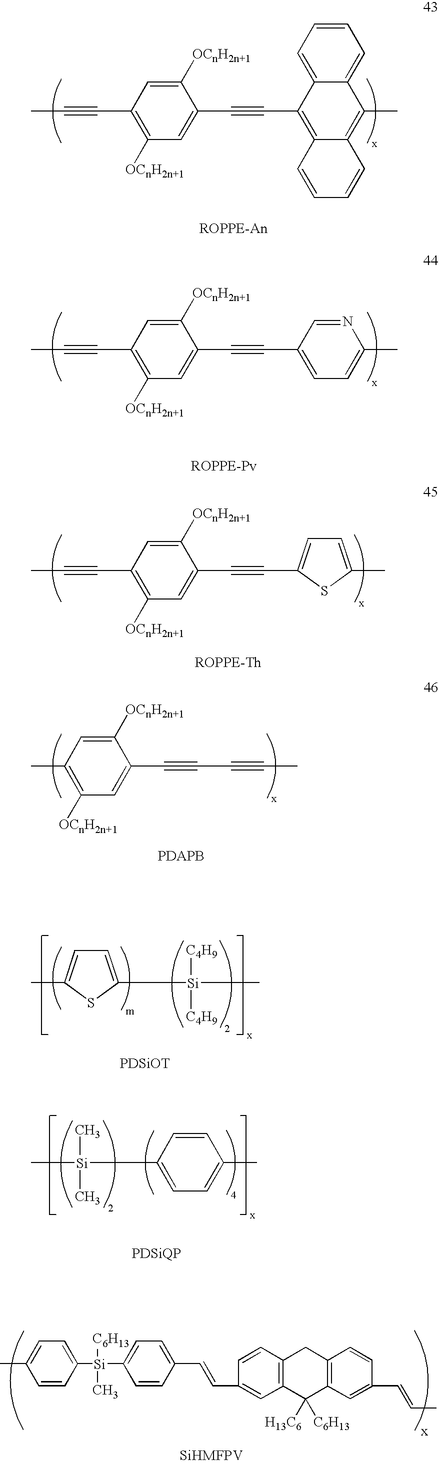

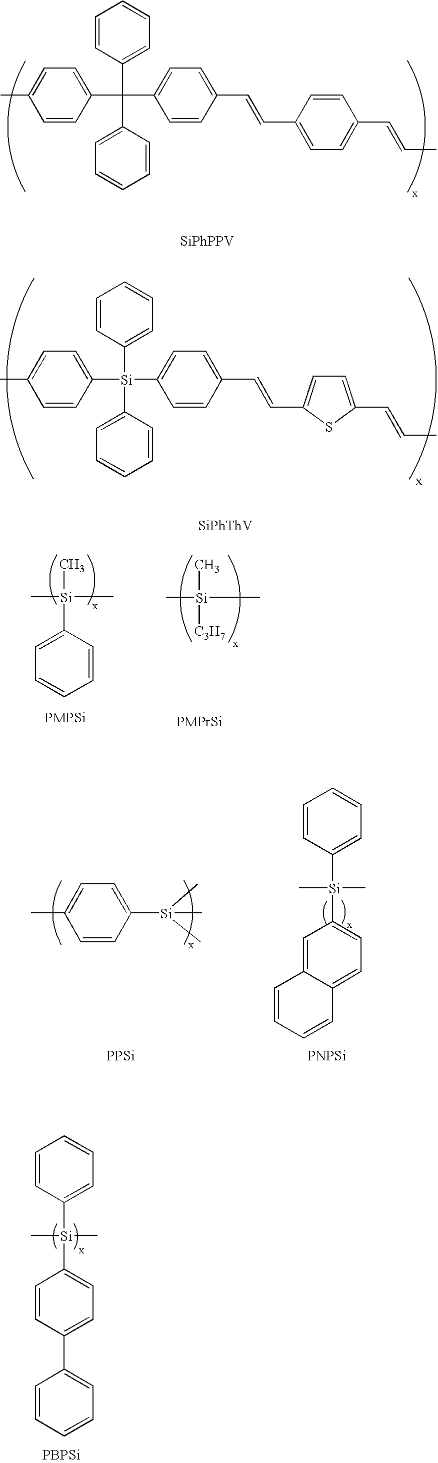

In the above-described exemplary compounds 1 to 46, more preferable electric conductive polymer materials are π-conjugated system compounds represented by exemplary compounds 12 to 46. Further, preferably utilized can be each electric conductive compound described in U.S. Pat. Nos. 5,504,323, 5,523,555, 5,331,183, 5,454,880, 5,196,144 and 4,145,462.

In the invention, specifically preferable electric conductive polymer materials include such as poly(2-methoxy-5-(2′-ethylhexyloxy)-p-phenylene pyrene), poly(3-alkylthiophene), poly(2-butyl-5-(2-ethylhexyl)-1,4-phenylenevinylene), poly(cyanophenylenevinylene) and poly(3-alkylthiophene). Further, an electric conductive polymer material according to the invention is preferably soluble in an organic solvent.

In the invention according to feature (15), a digital still camera is characterized in that a photoelectric conversion portion of an organic image sensor contains furalene or a carbon nanotube.

By utilizing a compound having a steric π-elecron cloud such as furalene and a carbon nanotube, carrier transfer or carrier trap between compounds can be performed efficiently, which is preferable since it advantageously contributes to sensitivity required for photographing by a digital still camera. These compounds include, for example, such as furalene C-60, furalene C-70, furalene C-76, furalene C-78, furalene C-84, furalene C-240, furalene C-540, mixed furalene, furalene nanotubes, multi walled nanotubes, single walled nanotubes, MB5015-00, MB6015-00, SR500, SR525, SR600 and SR625, manufactured by Highperione Co. Further, in furalene and a carbon nanotube introduced may be substituenets, to provide compatibility to solvents.

In the invention according to feature (16), a digital still camera is characterized in that a photoelectric conversion portion of an organic image sensor contains a charge-transporting material.

Preferable compounds as a charge-transporting material include, for example, such as quinolynol derivative metal complexes represented by 8-hydroxy quinoline aluminum, a tropolone metal complex, a flavonol metal complex, metal complexes of 10-hydroxybenzo [h]quinoline derivatives (except those having an alkaline metal as a center metal), perylene derivatives, perynone derivatives, naphthalene, coumarin derivatives, oxadiazol derivatives, aldazine derivatives, bistyryl derivatives, pyrazine derivatives, phenanthroline derivatives, triazol series compounds, naphtholic acid imido derivatives, silacyclopentadiene derivatives and indolocarbazol derivatives. Further, preferably utilized in the invention are electron-transporting materials described in each bulletin of such as Japanese Patent Nos. 2869378 and 2918150, JP-A Nos. 4-320486, 9-5448, 11-176578, 11-273856, 11-307260, 2001-250690, 2002-124388, 2002-117981, 2002-83681, 2002-63989, 2001-338767, 2001-313178, 2001-338761, 2001-284054 and 2001-281966.

Further preferable specific examples of an electron-transporting material utilized in the invention are listed below, however, the invention is not limited thereto.

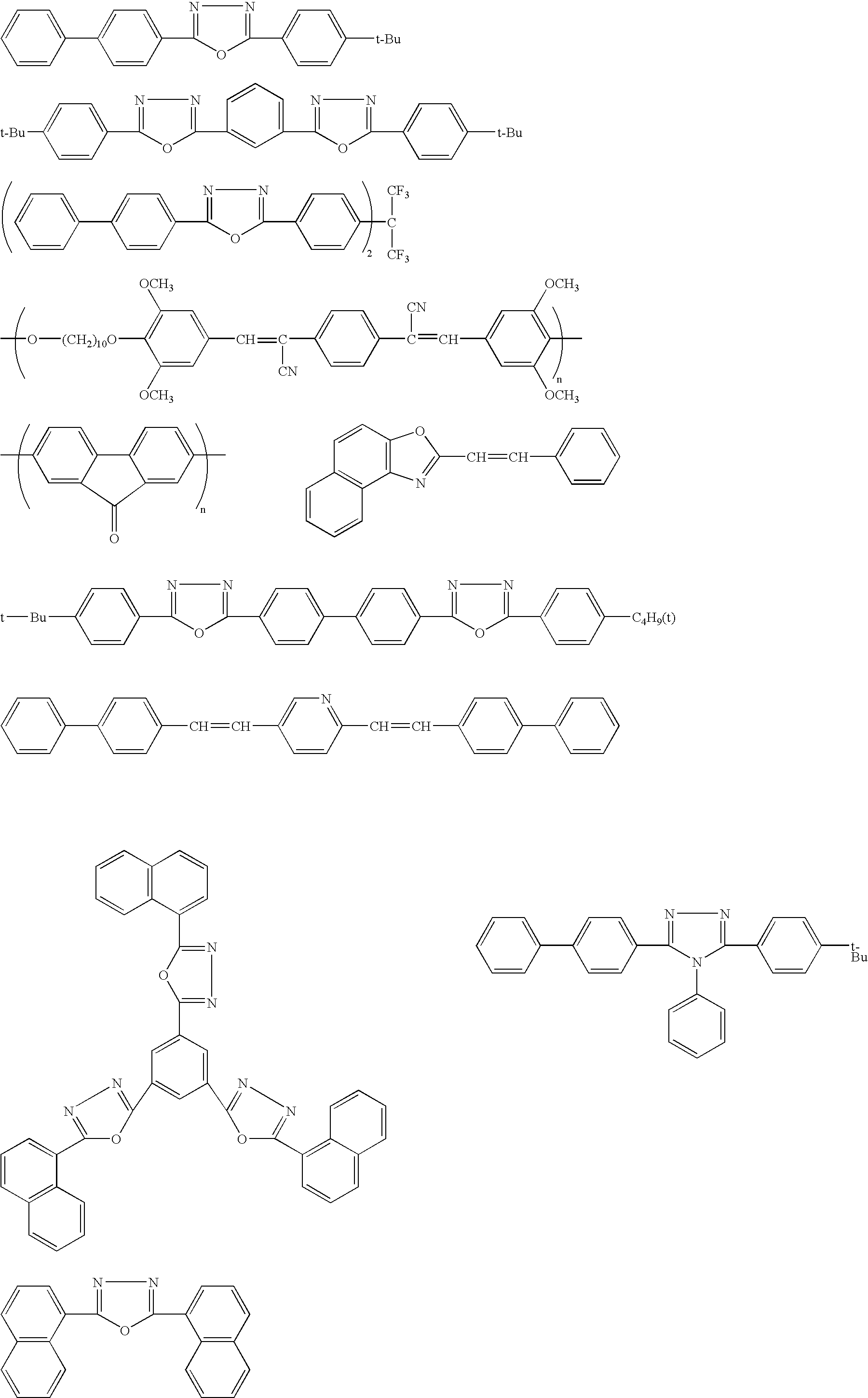

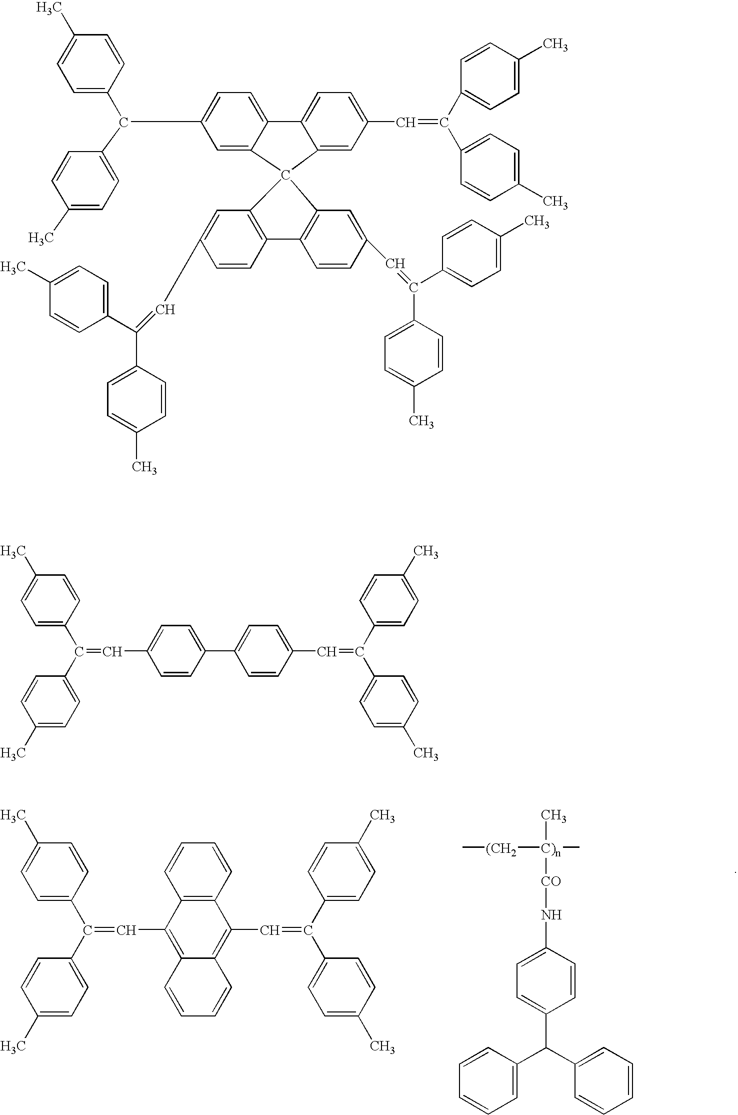

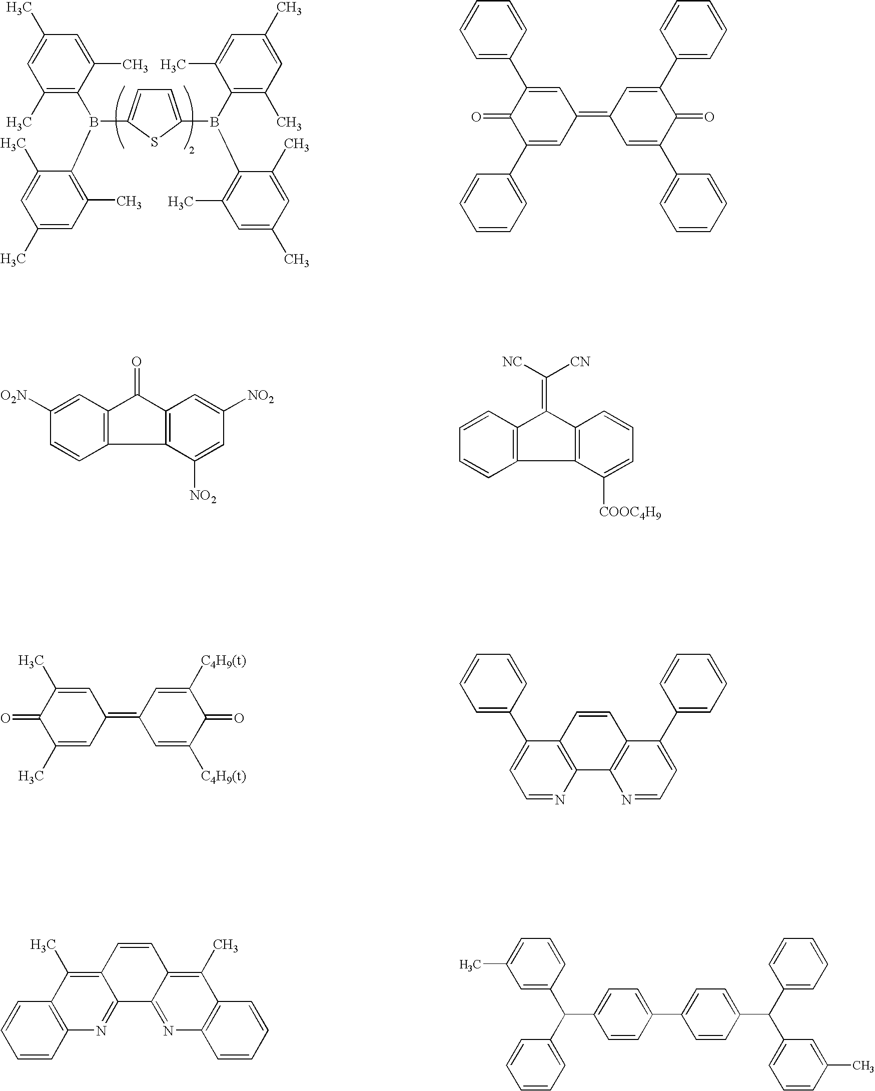

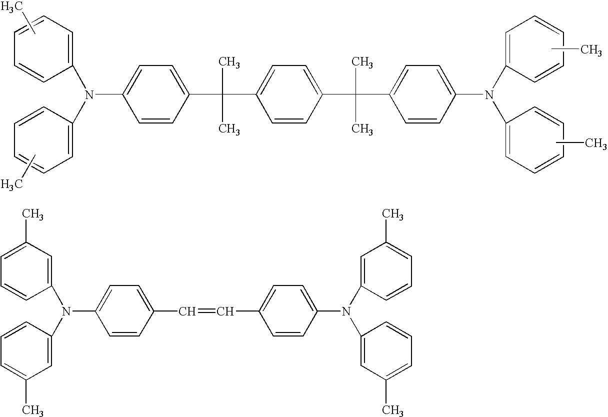

These electron-transporting materials may be utilized alone, or by being accumulated or mixed with different electron-transporting materials.

In the invention according to feature (17), a digital still camera is characterized in that a photoelectric conversion portion of an organic image sensor contains a hole-transporting material.

Preferable compounds as a hole-transporting material include, for example, such as triphenylamine series compounds, fluornyldiphenylamine derivatives, polysilane series compounds, bisenamine series derivatives and iminostyrbene series compounds. Further, preferably utilized in the invention are hole-transporting materials described in each bulletin of such as Japanese Patent Nos. 2560928, 2721441, 2949966, 2806144, 2848189, 2734558, 2848207, 2591461 and 2686418, Japanese Patent Publication No. 7-110940, JP-A Nos. 8-188773, 5-25473, 8-48656, 8-251947, 8-251949, 8-240922, 8-259956, 8-259957, 8-298185, 8-306490, 8-325564, 9-59256, 9-151571, 8-259940 and 11-26163.

Further preferable specific examples of a hole-transporting material utilized in the invention are listed below, however, the invention is not limited thereto.

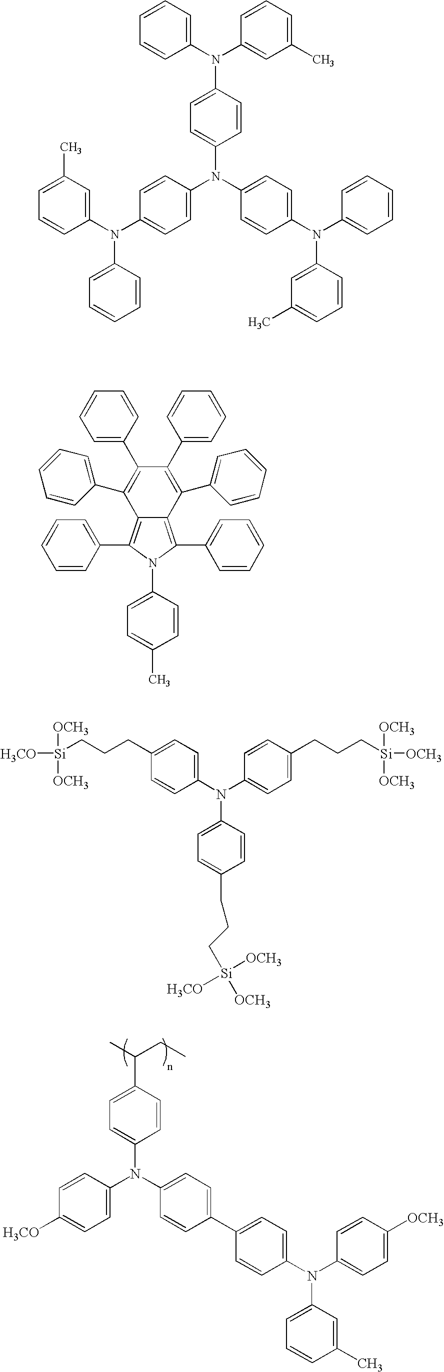

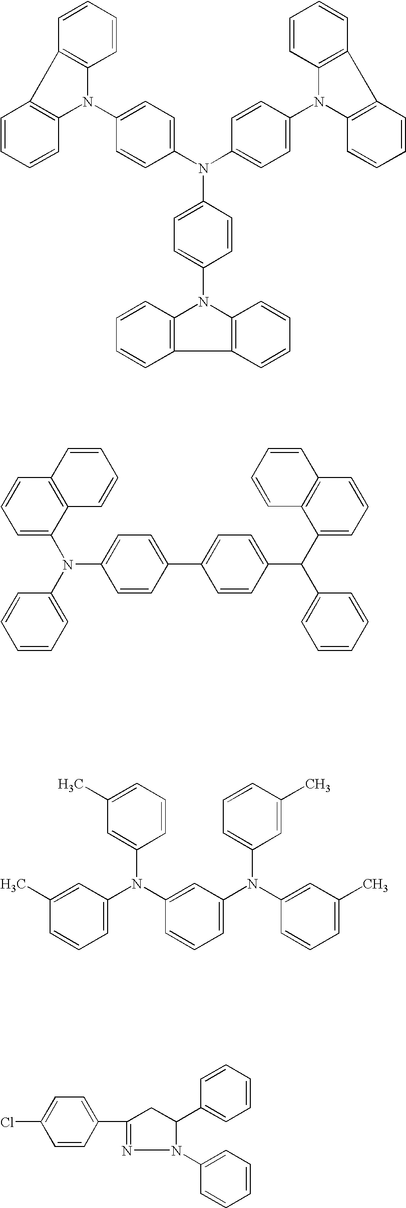

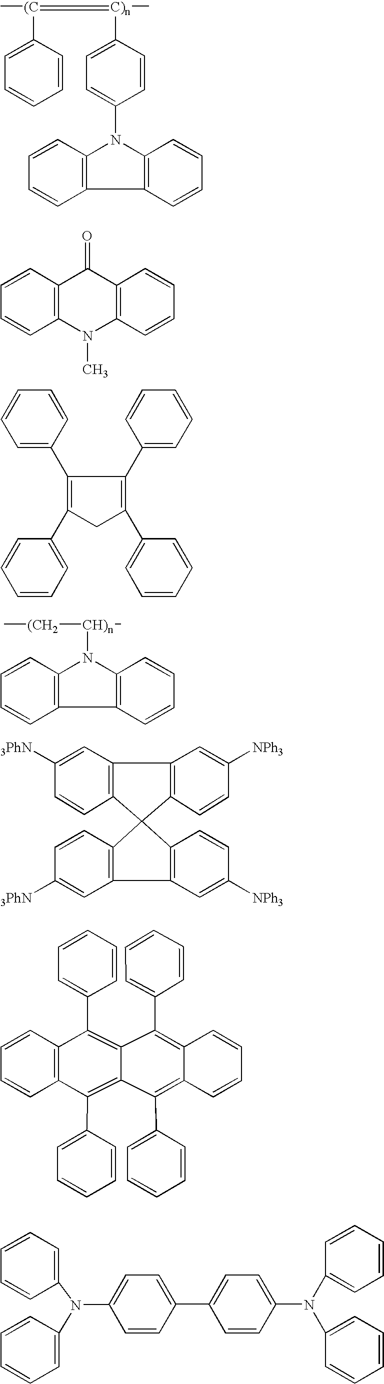

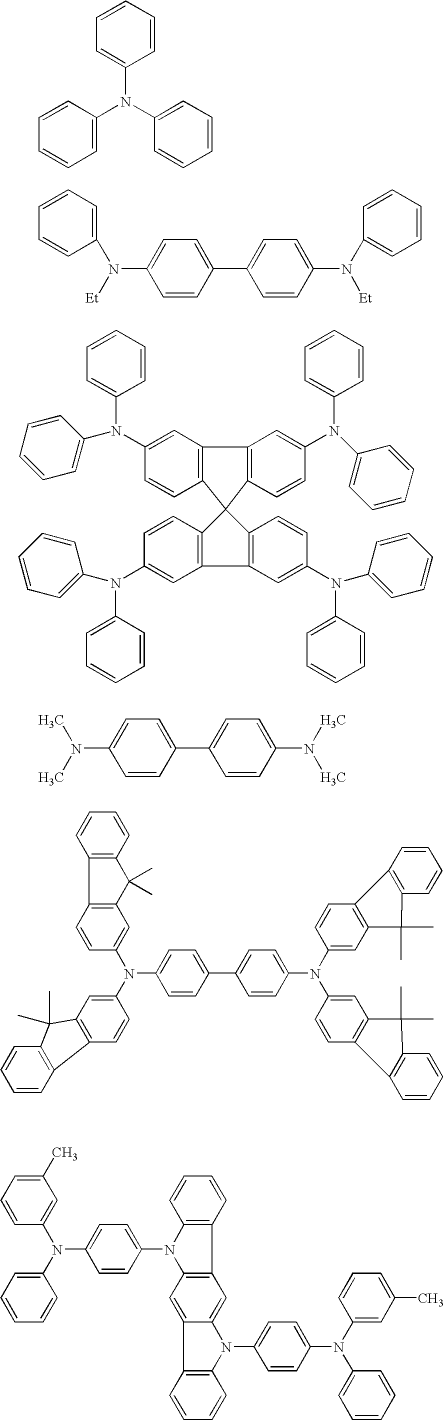

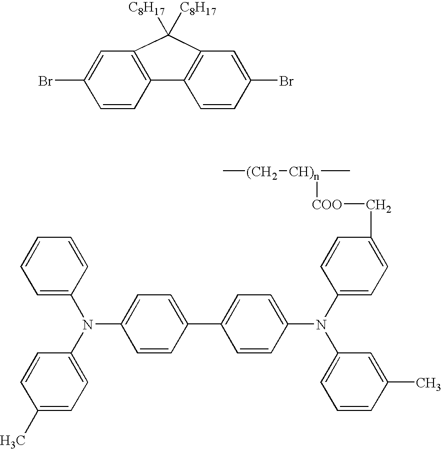

These hole-transporting materials may be utilized alone, or by being accumulated or mixed with different hole-transporting materials.

The above electron-transporting material or hole-transporting material may be utilized in the same layer containing each compound according to features 11 to 15 or in other layers. Further, functions of an electron-transporting material and a hole-transporting material are determined by the relationship with an energy level of a corresponding compound, and not limited to the above compounds.

Organic pigments having a particle diameter of not less than 0.1 nm and not more than 1000 nm, electric conductive polymer materials, furalene or carbon nanotubes, charge-transporting materials, hole-transporting materials, titanium oxide, tin oxide, or tungsten oxide, which are explained above, can be preferably utilized, for example, in a red-light detecting layer, a green-light detecting layer or a blue-light detecting layer of above-described FIGS. 2 to 4.

The above materials utilized in a hole-transporting layer, a charge-generating layer and an electron-transporting layer can form each layer by themselves, however, can be utilized also by being dispersed in polymer binders; soluble resins such as polyvinyl chloride, polycarbonate, polystyren, poly(N-vinylcarbazol), polymethyl methacrylate, polybutyl methacrylate, polyester, polysulfone, polyphenyleneoxide, polybutadiene, a hydrocarbon resin, a ketone resin, a phenoxy resin, polysulfone, polyamide, ethyl cellulose, vinyl acetate, an ABS resin and polyurethane resin; and curable resins such as a phenol resin, a xylene resin, a petroleum resin, an urea resin, a melamine resin, an unsaturated polyester resin, an alkyd resin, an epoxy resin and a silicone resin.

In the invention according to feature (18), a digital still camera is characterized in that an image-capturing plane of an organic image sensor is non-flat. There are disclosed a 360-degree supervision system equipped with one camera and a rotatable mirror which reflects light from a supervised object in JP-A No. 8-194809, a camera system which captures images of all 360-degree directions by rotating a line sensor on a rotating table capable of rotating 360 degrees in JP-A No. 11-205650, and a panorama photographing apparatus which captures images by placing a camera on a tripod head capable of rotating 360 degrees in JP-A 6-350887, however, all utilize a photographing means having a flat image-capturing plane to disclose none of requirements of the invention.

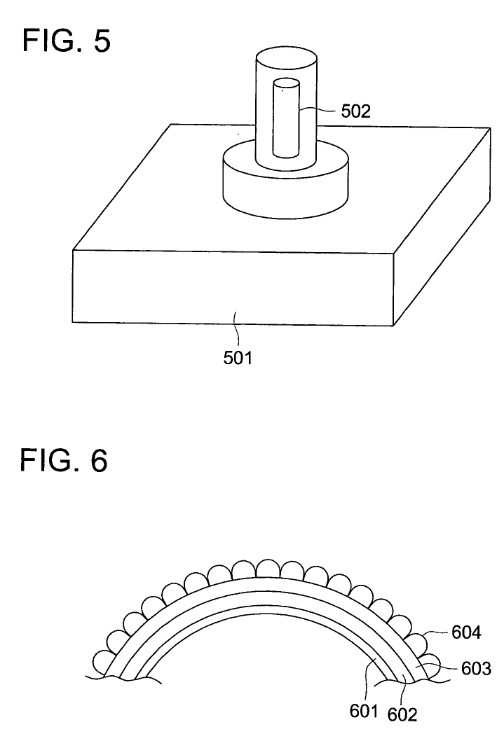

FIG. 5 is an oblique view drawing illustrating an example of a digital still camera equipped with a cylindrical sensor (an organic image sensor) having a non-flat image-capturing plane according to the invention, and FIG. 6 is a cross-sectional drawing illustrating an example of a constitution of a cylindrical sensor.

In the examples described in each of the above-described bulletins, a mechanical driving device to rotate a lens, a mirror or a camera itself is necessary, while a digital still camera equipped with cylindrical sensor 502, of which an image-capturing plane is non-flat on signal-processing portion 501 of FIG. 5 requires no driving device, and can achieve a grate store of image information and shortening of image processing time due to capability of simultaneous photographing of a 360-degree image, resulting in a superior supervision camera.

In a cylindrical sensor illustrated in FIG. 6, electrode 602 and photoelectric converter layer 603 are accumulated on cylindrical substrate 601, and micro-lenses 604 are arranged on the whole surface of said sensor to photograph an image of 360-degree.

In the invention according to feature (19), a digital still camera is characterized in that a generated charge-processing portion is equipped with an organic image sensor containing an organic semiconductor.

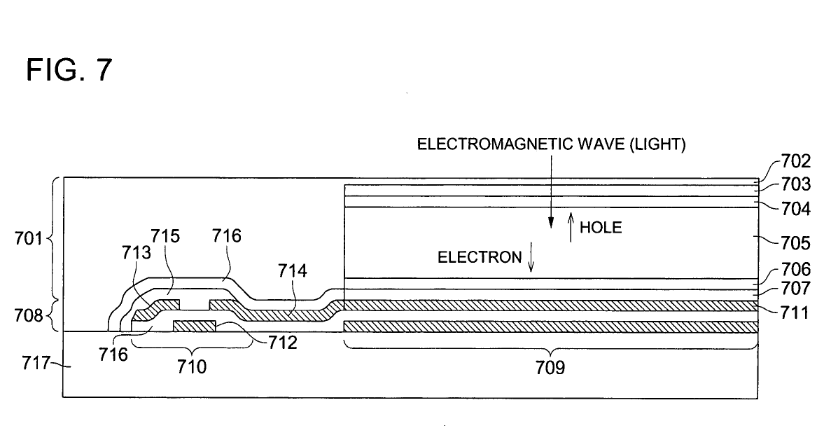

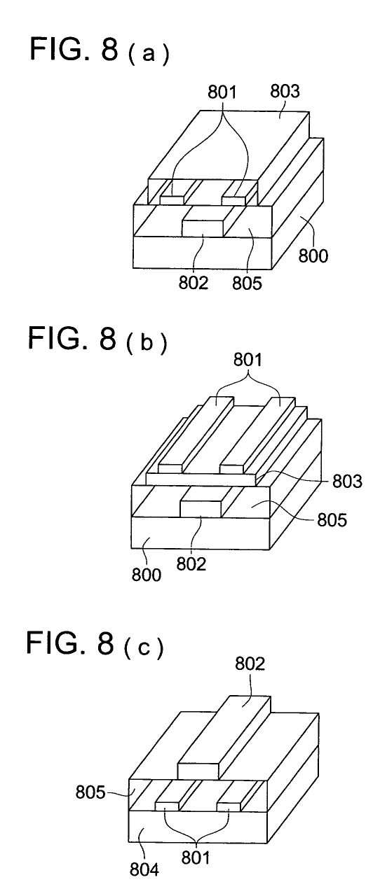

FIG. 7 is a cross sectional drawing illustrating an example of an organic image sensor containing an organic semiconductor. An organic image sensor illustrated in FIG. 7 is provided with first layer 701 (a photoelectric conversion portion) which converts incident electromagnetic wave (light) to electric energy. In the first layer 701, provided with are barrier layer 702, transparent electrode film 703, hole-conducting layer 704, charge-generating layer 705, electron-conducting layer 706 and electric conductive layer 707 in this order from the incident side of electromagnetic wave. Herein, charge-generating layer 705 contains a compound capable of generating an electron or a hole by electromagnetic wave (light) which can be subjected to photoelectric conversion, and can be provided with several separately functioned layers to perform photoelectric conversion smoothly.

Barrier layer 702 separates first layer 701 from outer atmospheric environment and utilizes, for example, such as an organic material having a high dielectric constant, a sealing resin and oxi-nitride. Transparent electrode film 703 is formed by utilizing an electric conductive transparent material, for example, such as indium tin oxide (ITO) SnO₂ and ZnO. In the formation of transparent electrode film 703, a thin film can be formed by a method such as evaporation and sputtering. Further, a pattern having a desired shape can be formed also by a photo-lithographic method; or a pattern may be formed via a mask of desired shape at the time of evaporation or sputtering of the above electrode material when high pattern precision is not required (approximately not less than 10 μm). The transparent electrode film 703 preferably has a transmittance of not less than 10% and a sheet resistance of not more than a few hundreds Ω/cm. Further, film thickness is generally 10 nm-1 μm and preferably selected in a range of 10-200 nm. It is because a transparent electrode may become an island state when film thickness is not more than 10 nm, while long time is required for formation of a transparent electrode when film thickness is not less than 200 nm.

In charge-generating layer 705, electrons and holes are generated by electromagnetic wave (light) emitted from first layer 701. Holes generated therein are gathered in hole-conducting layer 704 and electrons in electron conducting layer 706. Incidentally, hole conducting layer 704 and electron conducting layer 706 are not always essential in the constitution.

Electric conductive layer 707 is comprised, for example, of such as chromium. Further, it can be selected from general metal electrodes or from the above-described transparent electrodes, however, it is preferably comprised of metals, alloys, electric conductive materials and mixtures thereof, which have a small work function (not more than 4.5 eV) as an electrode substance to obtain superior characteristics. Specific examples of such electrode substances include such as sodium, sodium-potassium alloy, magnesium, lithium, aluminum, a magnesium/copper mixture, a magnesium/silver mixture, a magnesium/aluminum mixture, a magnesium/indium mixture, an aluminum/aluminum oxide (Al₂O₃) mixture, indium, a lithium/aluminum mixture and rare earth metals. The conductive layer 707 can be formed by utilizing these electrode substances as a raw material and by means of a method such as evaporation or sputtering. Further, sheet resistance of electric conductive layer 707 is preferably not more than a few hundreds Ω/cm, and layer thickness is generally selected in a range of 10 nm-1 μm and preferably of 50-500 nm. It is because an electric conductive layer may become an island state when film thickness is not more than 10 nm, while long time is required for formation of a conductive layer when film thickness is not less than 1 μm.

Next, above-described hole-conducting layer 704, charge-generating layer 705 and electron-conducting layer 706 will be detailed. A constitution of a so-called organic EL element can be applied to charge-generating layer 705, and said organic EL element may be either of a low molecular weight type, and of a polymer type, a so-called light emitting polymer. Exemplary compounds utilized in an organic EL element include such compounds described at pages 190-203 of “Organic EL Materials and Display (Nov. 30, 1998, published by C.M.C. Co. Ltd.)”, and compounds described at pages 81-99 of “Organic EL Elements and Front-most of Industrialization Thereof (Nov. 30, 1998, published by N.T. S. Co.)”. Materials utilized in the above-described organic EL element of a low molecular weight type include such compounds described at pages 36-56 of “Organic EL Elements and Front-most of Industrialization Thereof (Nov. 30, 1998, published by N.T.S. Co.)”, and compounds described at pages 148-172 of “Organic EL Materials and Display (Feb. 28, 2001, published by C.M.C. Co. Ltd.)”.

Further, as a material used in a photoelectric conversion portion, also preferably utilized can be organic pigments having a particle diameter of 1-1000 nm, electric conductive polymer materials, furalene or carbon nanotubes, electron-transporting materials, hole-transporting materials, titanium oxide, tin oxide, or tungsten oxide, described above.

In second layer 708 of FIG. 7, formed is a layer (a generated charge processing section) which accumulates electric energy obtained in first layer 701 and outputs signals based on the accumulated electric energy. Second layer 708 is constituted by use of condenser 708, which store electric energy generated in first layer 701 by each pixel, and transistor 710, which is a switching device to output stored electric energy as a signal. Second layer 708 is not limited to those utilizing a switching device but of a constitution in which signals corresponding to the stored electric energy is generated and output.

As transistor 710, suppose, for example, a TFT (a thin layer transistor) is utilized. As the TFT, may be utilized an inorganic semiconductor type or an organic semiconductor, and TFT formed on a plastic film is also a preferable constitution. As a TFT formed on a plastic film, an amorphous silicone type is known, in addition, utilized may be also another type in which, FSA technique developed by Alien Technology Co in USA is applied, that is, a TFT is formed on a plastic film by arranging fine CMOS (nanoblocks) made of single crystal silicon on a embossed plastic film. Further, utilized may be a TFT comprised of organic semiconductors described in literatures such as Science 283,822 (1998), Appl. Phys. Lett., 771488 (1998) and Nature 403,521 (2000). Thus, as a switching device utilized in the invention, preferable are a TFT prepared by the above described FSA technique and a TFT constituted of an organic semiconductor, and specifically preferable is to utilize a TFT constituted of an organic semiconductor in a generated charge processing section. Constituting a TFT by utilizing the organic semiconductor can reduce a manufacturing cost, because not required is equipment like a vacuum evaporation apparatus, which is necessary in case of forming a TFT by utilizing an inorganic semiconductor such as silicon, and a TFT can be formed by a printing method or an inkjet method. In addition, a TFT can be formed also on a plastic substrate having poor heat resistance due to a low processing temperature.

Further, among TFT comprised of an organic semiconductor, a electric field effect transistor (FET) is particularly preferred and, specifically, organic TFT comprised of each structure shown in FIGS. (a) to (c) are preferred.

An organic TFT shown in FIG. (a) is comprised of gate electrode 802, gate insulating layer 805, source-drain electrode 801 and organic semiconductor layer 803 being accumulated in this order on substrate 800.

An organic TFT shown in FIG. (b) is comprised of gate electrode 802, gate insulating layer 805, organic semiconductor layer 803 and source-drain electrode 801 being accumulated in this order on substrate 800.

An organic TFT shown in FIG. (c) is comprised of source-drain electrode 801, gate insulating layer 805 and gate electrode 802 being accumulated in this order on organic semiconductor single crystal 804.

In an organic TFT, a compound comprising organic semiconductor layer 803 may be either a single crystal or an amorphous material, and either a low molecular weight material or a polymer material, and specifically preferable compounds include single crystals of condensed aromatic hydrocarbon compounds represented by such as benzene, triphenylene and anthrathene, and electric conductive polymer materials containing π-conjugated type polymers represented by above exemplary compounds 12 to 46.

A source electrode, a drain electrode and a gate electrode may be any of metals, conductive inorganic compounds and conductive organic compounds, however, are preferably comprised of a conductive organic compound in respect to easy preparation; the typical examples include a compound which contains a π-conjugated type polymer, doped with a Lewis acid (such as iron chloride, aluminum chloride, antimony bromide), a halogen (such as iodine and bromine) and sulfonate (such as a sodium salt of polystyrene sulfonate (PSS) or potassium p-toluenesulfonate), and a specific representative example includes an electric conductive polymer of polyethylene dioxythiophene (PEDOT) added with PSS.

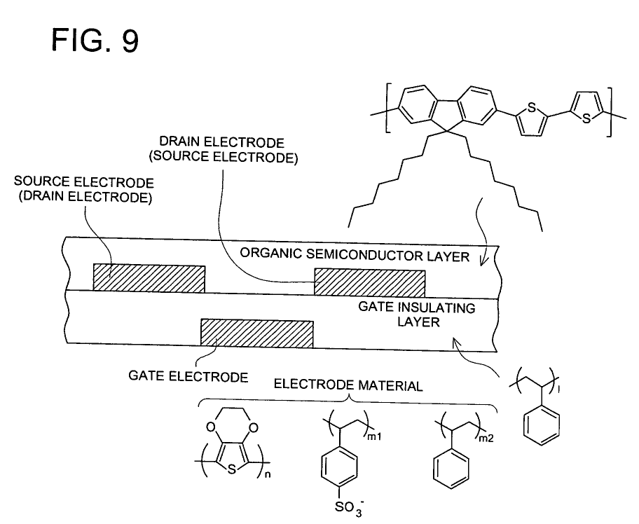

FIG. 9 is a cross sectional drawing showing a specific constitution of an organic TFT and an example of compounds utilized therein.

In the above-described FIG. 7, collective electrode 711, which accumulates electric energy generated in first layer 701 and functions as one side electrode for condenser 709, is connected to transistor 710 as a switching device.

In this condenser 701, electric energy generated in first layer 701 is accumulated and said electric energy is read out by drive of transistor 710. That is, a signal of each pixel can be generated by driving a switching device.

In FIG. 7, transistor 710 is constituted of gate electrode 712, source electrode (drain electrode) 713, drain electrode (source electrode) 714, organic semiconductor layer 715 and insulating layer 716.

Third layer 717 is an image sensor substrate. A substrate utilized preferably as third layer 717 is a plastic film, and includes films comprised of, for example, such as polyethylene terephthalate (PET), polyethylene naphthalate (PEN), polyether sulfone (PES), polyether imide, polyether etherketone, polyphenylene sulfido, polyallylate, polyimide, polycarbonate (PC), cellulose triacetate (TAC) and cellulose acetate propionate (CAP). In this manner, utilization of a plastic film can make an image sensor light-weighted as well as being improved of impact resistance, compared to the case of utilizing a glass substrate.

Further, the plastic films may be added with a plastisizer such as trioctyl phosphate and dibutyl phthalate, and with a well-known UV-absorbent such as a benzotriazol type and a benzophenone type. Further utilized as a raw material can be a resin prepared by applying a so-called organic-inorganic polymer hybrid method, in which an inorganic polymer raw material such as tetraehtoxy silane is added for polymerization by providing energy such as a chemical catalyst, heat or light. Further, a primary cell or a chargeable secondary cell, such as a manganese cell, a nickel-cadmium cell, a mercury cell and a lead cell, may be provided as an electric source portion on the opposite side of the second layer in third layer 717. As a form of the cell, flat shape is preferable to make an image sensor thinner.

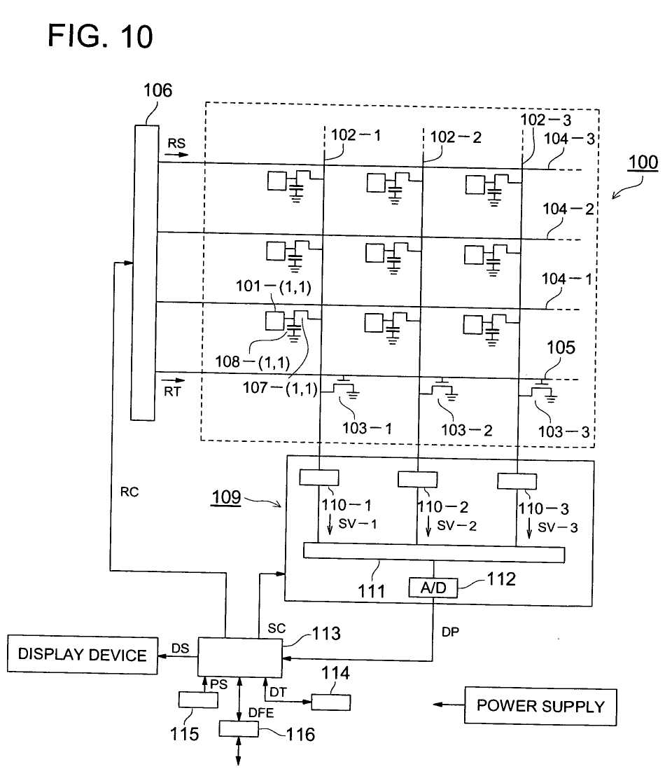

Next, a circuit constitution of an organic image sensor according to the invention will be explained. FIG. 10 shows an example of a circuit drawing of an organic image sensor according to the invention.

FIG. 10 shows a constitution of image sensor 100; in image sensor 100 collective electrode 101 to read out electric energy accumulated corresponding to strength of irradiated light is arranged two dimensionally, and the collective electrode 101 functions as a one-side electrode of condenser 108 to accumulate electric energy in condenser 108. Herein, one collective electrode 101 corresponds to one pixel of an emitted image.

In image sensor 100 according to the invention, provided are transistors for initiation 103-1 to 103-n, of which signal lines 102-1 to 102-n are connected to, for example, a drain electrode. Source electrodes of the transistors 103-1 to 103-n are grounded, and gate electrodes are connected to reset line 105.

Scanning lines 104-1 to 104-m and reset line 105 are connected to scan drive circuit 106, as shown in FIG. 10. When a read out signal RS is supplied from scan drive circuit 106 to one of scanning line 104-p (p is any value of 1 to m) among scanning lines 104-1 to 104-m, transistors 107-(p,1) to 107-(p,n) connected to this scanning line 104-p are made in an on-state and electric energy accumulated at condensers 108-(p,1) to 108-(p,n) is read out by each signal line 102-1 to 102-n. Signal lines 102-1 to 102-n are connected to signal converters 110-1 to 110-n of signal selection circuit 109, electric voltage signals SV-1 to SV-n, which are proportional to quantities of electric energy having been read out on signal lines 102-1 to 102-n are generated at signal converters 110-1 to 110-n. Voltage signals SV-1 to SV-n output from signal converter 110-1 to 110-n are supplied to resistor 111. In resistor 111, supplied voltage signals are selected successively to be converted to digital image signals (for example, of 12 bits or 16 bits) for each scanning line by A/D converter 112, and control circuit 113 brings in a digital image signal of each scanning line to generate image signals by supplying a read out signal RS to each scanning line 104-1 to 104-m via scan drive circuit 106 for image scanning. The image signals are supplied to control circuit 113. Further, when transistors 103-1 to 103n are made in an on-state by supplying a reset signal RT to reset line 105 from scan drive circuit 106 as well as transistors 107-(1,1) to 107-(m,n) are made in an on-state by supplying a read out signal RS to scanning lines 104-1 to 104-m, image sensor 100 can be initialized by electric energy stored in condensers 108-(1,1) to 108-(m,n) being discharged via transistors 103-1 to 103-n. Control circuit 113 is connected to memory section 114 and operation section 115, and actions of image sensor 100 are controlled based on an operation signal PS from operation section 115. Operation section 115 is provided with plural switches, and such as initialization of image sensor 100 and image signal generation are performed based on an operating signal PS corresponding to a switching operation at operation section 115. Further, control circuit 113 can be connected to other circuits via connector 116 and image signal generation may be performed also by controlling image sensor 100 from other circuits.

An organic image sensor according to the invention is preferably provided with a sealing structure so as not to be affected by external environment such as humidity. A sealing method can include methods described, for example, in each bulletin of JP-A Nos. 11-223890, 11-249243, 11-344589 and 2000-171597.

In the invention according to feature (20), a digital still camera is characterized by including an organic image sensor being prepared by an inkjet method in at least one process.

An inkjet method according to the invention is a method in which such as images, characters and symbols are formed on a recording medium by making ink into tiny droplets and being ejected through an ejection outlet such as a fine nozzle. A method to eject ink includes such as a method, in which ink being filled in a head is ejected as ink liquid drops of a desired size based on mechanical signals having been converted from electric signals by use of a piezo-element, and a method, in which ink is ejected by utilizing volume change of ink having been subjected a thermal action such as described in JP-A No. 54-59936. As an inkjet recording apparatuses, preferably utilized are apparatuses described in each bulletin of JP-A Nos. 2002-178487, 2002-178486, 2002-17805, 2002-17806, 2002-103594 and 2002-52719. Further, utilized can be manufacturing methods described in JP-A No. 11-73158, WO Nos. 99/40871, 99/53484, JP-A Nos. 2000-353594, 2001-64529, 2001-279134, 2001-313172, 2001-284047, 2002-215065, 2002-22269 and 2002-231447, and U.S. Pat. No. 6,087,196.

It is preferable to utilize an inkjet method because possible are reduction of manufacturing cost and improvement of productivity of a small-lot product.

In the invention according to feature (21), a digital still camera is characterized by including an organic image sensor being prepared by a printing method in at least one process.

For example, electrodes 208-211 shown in FIG. 2, photoelectric conversion section 202, 204, 206, also in FIG. 2, or drain, source and gate shown in FIG. 9 are formed by depositing respective materials with the use of inkjet method or printing method.

A printing method according to the invention includes, for example, such as a relief printing method, a gravure printing method, an off-set printing method and a screen printing method. Among them, preferably utilized in the invention is a gravure printing method or a screen printing method. Specific methods include methods described in such as JP-A Nos. 2001-160565, 2001-118864, 2001-274432, 2001-274447, 2002-134792, 2002-76587, 2001-158248, 2002-124692, 2002-204049 and 2002-25768.

Effect of the Invention

The invention can provide a new digital still camera, which utilizes an organic image sensor as an image-capturing device, solves each disadvantage of a photographing system utilizing a silver halide photographic material and a digital still camera system by use of a solid image-capturing device comprised of an inorganic material, and has a high sensitivity, a wide dynamic range and a merit of a reduced cost; and a manufacturing method thereof.

What is claimed is:

1. A digital still camera comprising:
an organic image sensor for capturing an image;
a lens having an aperture value F; and
a shutter having a shutter speed T (sec);
wherein, a exposure value EV of the digital still camera is not less than 6 and not more than 15, where the exposure value EV is represented by the following equation;
EV=3.32 log₁₀ (F²/T).

2. A digital still camera comprising:
an organic image sensor, for capturing an image, having an image-capturing device sensitivity index SV; and
a lens having an aperture value F;
a shutter having a shutter speed T (sec);
wherein a system sensitivity index S of the digital still camera is not less than 0 and not more than 4.5, where the system sensitivity index S is represented by the following equations;
S=exposure value EV−SV
EV=3.32 log₁₀ (F²/T).

3. The digital still camera of claim 2, wherein a exposure value EV of the digital still camera is not less than 6 and not more than 15.

4. The digital still camera of claim 3, further comprising a strobe, wherein a guide number of the strobe is not greater than 10.

5. The digital still camera of claim 3, wherein the exposure control section comprises a fixed focus mechanism and a fixed aperture mechanism.

6. The digital still camera of claim 3, wherein the digital still camera is reusable through collection after being used.

7. A digital still camera comprising:
an organic image sensor for capturing an image; and
a lens having an aperture value F; and
a shutter having a shutter speed T (sec);
wherein a photoelectric conversion section of the organic image sensor has an opening area ratio of not less than 80% and less than 100%.

8. The digital still camera of claim 7, wherein a size (a side length) of a pixel in the organic image sensor is not less than 2 μm and not greater than 200 μm.

9. The digital still camera of claim 7, wherein a size (a side length) of a pixel in the organic image sensor is not less than 20 μm and not greater than 200 μm.

10. The digital still camera of claim 7, wherein a size (a side length) of an image-capturing plane in the organic image sensor is not less than 24 mm and not greater than 150 mm.

11. The digital still camera of claim 7, wherein a size (a side length) of an image-capturing plane in the organic image sensor is not less than 35 mm and not greater than 150 mm.

12. A digital still camera comprising:
an organic image sensor for capturing an image;
a lens having an aperture value F; and
a shutter having a shutter speed T (sec);
wherein, a size (a side length) of a pixel in the organic image sensor is not less than 2 μm and not greater than 200 μm, and a size (a side length) of an image-capturing plane in the organic image sensor is not less than 24 mm and not greater than 150 mm.

13. A digital still camera comprising:
an organic image sensor, for capturing an image, having an image-capturing device sensitivity index SV;
a lens having an aperture value F; and
a shutter having a shutter speed T (sec);
wherein a system sensitivity index S of the digital still camera is not less than 0 and not more than 4.5, and a exposure value EV of the digital still camera is not less than 6 and not more than 15; where the system sensitivity index S and the exposure value EV are represented by the following equations;
S=EV−SV
EV=3.32 log₁₀ (F²/T),
wherein a size (a side length) of a pixel in the organic image sensor is not less than 2 μm and not greater than 200 μm, and a size (a side length) of an image-capturing plane in the organic image sensor is not less than 24 mm and not greater than 150 mm.

14. The digital still camera of claim 12, wherein the organic image sensor has at least three maximum spectral sensitivity values, and each wavelength, λₘₐₓ₁, λₘₐₓ₂ and λₘₐₓ₃, providing the maximum spectral sensitivity value, satisfies the following formulas (1) to (3),
400 nm<λₘₐₓ₁<500 nm Formula (1)
500 nm<λₘₐₓ₂<600 nm Formula (2)
600 nm<λₘₐₓ₃<700 nm. Formula (3)

15. The digital still camera of claim 14, wherein each wavelength, λ_{max1 (80)}, λ_{max2 (80)} and λ_{max3 (80)}, of the organic image sensor, which provides 80% of the maximum spectral sensitivity value at the longer wave length side of each of the wavelength, λₘₐₓ₁, λₘₐₓ₂ and λₘₐₓ₃ satisfies the following formulas (4) to (6),
50 nm≧λ_{max1 (80)}−λₘₐₓ₁≧25 nm Formula (4)
50 nm≧λ_{max2 (80)}−λₘₐₓ₂≧25 nm Formula (5)
50 nm≧λ_{max3 (80)}−λₘₐₓ₃≧25 nm. Formula (6)

16. The digital still camera of claim 12, wherein the organic image sensor comprises multiple lamination layers which are capable of detecting blue-light, green-light and red-light.

17. The digital still camera of claim 12, wherein a photoelectric conversion section of the organic image sensor comprises at least one of titanium oxide, zinc oxide, tin oxide and tungsten oxide.

18. The digital still camera of claim 12, wherein a photoelectric conversion section of the organic image sensor comprises an organic pigment having a particle diameter of not less than 0.1 nm and not more than 1000 nm.

19. The digital still camera of claim 12, wherein a photoelectric conversion section of the organic image sensor comprises an electric conductive polymer material.

20. The digital still camera of claim 12, wherein a photoelectric conversion section of the organic image sensor comprises at least one of a furalene and a carbon nanotube.

21. The digital still camera of claim 12, wherein a photoelectric conversion section of the organic image sensor comprises a charge-transporting material.

22. The digital still camera of claim 12, wherein a photoelectric conversion section of the organic image sensor comprises a hole-transporting material.

23. The digital still camera of claim 12, wherein a generated charge processing section of the organic image sensor comprises an organic semiconductor.

24. A digital still camera comprising:
an organic image sensor for capturing an image;
wherein, the organic image sensor comprises a non-flat image-capturing plane.

25. A manufacturing method of a digital still camera provided with an organic image sensor, comprising the step of preparing the organic image sensor by utilizing an ink-jet method in at least one process of preparation.

26. A manufacturing method of a digital still camera provided with an organic image sensor, comprising the step of preparing the organic image sensor by utilizing a printing method in at least one process of preparation.
